(19) United States
(12) Patent Application Publication
(10) Pub. No.: US 2013/0050130 A1
(43) Pub. Date: Feb. 28, 2013

(54) TOUCH PANEL AND DISPLAY DEVICE WITH DIFFERENTIAL DATA INPUT

(71) Applicant: Christopher James BROWN, Oxford (GB)

(72) Inventor: Christopher James BROWN, Oxford (GB)

(73) Assignee: SHARP KABUSHIKI KAISHA, Osaka (JP)

(21) Appl. No.: 13/214,346

(22) Filed: Aug. 22, 2011

(51) Int. Cl. G06F 3/045

(52) U.S. Cl. 345/174

(57) ABSTRACT

A touch panel and display device is provided which includes a projected capacitance type touch panel; and a display, the display including a plurality of pixels each including a pixel circuit having differential data inputs.

### TECHNICAL FIELD

The present invention relates to touch panel and display devices. In particular, this invention relates to projected capacitance touch panels integrated with liquid crystal display (LCD) devices. Such an LCD device with integrated touch panel may find application in a range of consumer electronic products including, for example, mobile phones, tablet and desktop PCs, electronic book readers and digital signage products.

### BACKGROUND ART

Touch panels have recently become widely adopted as the input device for high-end portable electronic products such as smart-phones and tablet PCs. Although, a number of different technologies can be used to create these touch panels, capacitive systems have proven to be the most popular due to their accuracy, durability and ability to detect touch input events with little or no activation force.

The most basic method of capacitive sensing for touch panels is demonstrated in surface capacitive type touch panels (also known as self-capacitance type touch panels), for example as disclosed in U.S. Pat. No. 4,293,734 (Pepper, Jr., Oct. 6, 1981). A typical implementation of a surface (self) capacitance type touch panel is illustrated in FIG. 1 and comprises a transparent substrate 10, the surface of which is coated with a conductive material that forms a sensing electrode 11. One or more voltage sources 12 are connected to the sensing electrode, for example at each corner, and are used to generate an electric field which extends above the substrate. When a conducting object, such as a human finger 13, comes into close proximity to the sensing electrode, a capacitor 14 is dynamically formed between the sensing electrode 11 and the finger 13 and this field is disturbed. The capacitor 14 causes a change in the amount of current drawn from the voltage sources 12 wherein the magnitude of current change is related to the distance between the finger location and the point at which the voltage source is connected to the sensing electrode. Current sensors 15 are provided to measure the current drawn from each voltage source 12 and the location of the touch input event is calculated by comparing the magnitude of the current measured at each source. Although simple in construction and operation, surface capacitive type touch panels are unable to detect multiple simultaneous touch input events as occurs when, for example, two or more fingers are in contact with the touch panel.

Another well-known method of capacitive sensing applied to touch panels can be found in projected capacitive type touch panels (also known as mutual capacitance type touch panels). In this method, as shown in FIG. 2, a drive electrode 20 and sense electrode 21 are formed on a transparent substrate (not shown). The drive electrode 20 is fed with a changing voltage or voltage excitation signal by a voltage source 22. A signal is then generated on the adjacent sense electrode 21 by means of capacitive coupling via the mutual coupling capacitor 23 formed between the drive electrode 20 and sense electrode 21. When a conductive object such as a finger 13 is brought into the proximity of the electrodes, the magnitude of the mutual capacitance 23 is altered according to the distance between the conducting object and the electrodes. A current measurement means 24 is connected to the sense electrode 21 and provides a measurement of the size of the mutual coupling capacitor 23. A touch input event may therefore be detected by monitoring the output of the current measurement means 24. As is well-known, by arranging a plurality of drive and sense electrodes in an array, such as a two-dimensional matrix array, this projected capacitance sensing method may be used to form a touch panel device. An advantage of the projected (mutual) capacitance sensing method over the surface (self) capacitance method is that multiple simultaneous touch input events may be detected.

Capacitive type touch panel devices such as those described above have been widely adopted in consumer electronic products and it is desirable to improve several key aspects of their mechanical, optical and electrical properties. In particular it is desirable that the thickness and weight of both the touch panel device itself and of the combined module containing the touch panel and display be reduced. Well-known approaches to achieve this reduction include: laminating the touch panel on top of the display; forming the touch panel electrodes directly on the top surface of the display substrate (commonly referred to as an “on-cell” touch panel); or forming the touch panel electrodes within the display itself (commonly referred to as an “in-cell” touch panel). For example, “Touch Panel Embedded LCD using Conductive Overlay”, H. Haga et al, p 2143-2146, Proceedings of the 16^{th} International Display Workshops (2009) describes an on-cell type arrangement comprising a surface capacitance type touch panel and an active matrix liquid crystal display (AMLCD). Alternatively, “A Novel Design for Internal Touch Display”, P. Sheng-Zeng et al, p 567-569, Proceedings of the 47^{th} International Symposium of the Society for Information Display (2009) describes an on-cell type arrangement comprising a projected capacitance type touch panel and an AMLCD. Although these devices may successfully reduce the thickness of the module, as the touch panel and display are brought closer together the amount of electrical interference between the two increases. This interference arises from the increased capacitive coupling between electronic layers of the touch panel and display as the distance between them is decreased and may have the undesirable result of causing a malfunction in the touch panel operation. In order to ensure correct operation, it is therefore desirable to increase the signal-to-noise ratio (SNR) of the touch panel device.

One known approach to increasing the SNR is to optimize the sensitivity of the touch panel to the proximity of a conductive object, such as a finger, through the design of the touch panel electrodes. For example, U.S. Pat. No. 5,543,588 (Bisset et al, Aug. 6, 1996) discloses a touch panel including drive and sense electrodes patterned into diamond shapes. Alternatively, US Patent Application No. 2010/0302201 (Ritter et al, Dec. 2, 2010) discloses a touch panel including inter-digitated drive and sense electrodes which may be formed in a single physical layer. A disadvantage of increasing the sensitivity of the touch panel to the proximity of a conductive object in this way however is that the sensitivity of the touch panel to sources of electronic noise and interference may also be increased and the improvement in SNR that may be achieved by this approach is therefore limited.

A second approach to increase the SNR is to reduce the amount of electrical interference caused by the display and received by the touch panel. A well-known means of reducing such interference from the display is to synchronize the timing of the display and touch panel functions such that the touch panel is only active to detect touch input when the display function is inactive, for example during the display horizontal or vertical blanking periods. However, such a method imposes undesirable constraints on the touch panel operation which may limit the increase in SNR achievable. An effective means of improving the SNR of touch panel devices to enable successful implementation of on-cell type structures is therefore sought.

An alternative approach to reducing the thickness and weight of touch panel and display devices is the aforementioned “in-cell” touch panel. For example, US Patent Application No. 2008/0062139 (Hotelling et al, Mar. 13, 2008) discloses an AMLCD in which a capacitive type touch panel is formed on the TFT substrate of the display by the integration of a capacitance measurement circuit into each pixel of the display. However, this method has two significant disadvantages: firstly, the magnitude of the change in capacitance in each pixel due to the proximity of a conductive object is extremely small; and secondly, the touch panel function is susceptible to electrical interference from the display. Accordingly, since the touch panel sensitivity is low and the amount of electrical interference is high, the SNR is poor and the operation of the touch panel is therefore unreliable. In addition, an extra transistor is required in each pixel thus reducing the aperture ratio of the display.

Another type of in-cell touch panel device, disclosed in US Patent Application No. 2010/0001973 (Hotelling et al, Jan. 7, 2010), includes a touch panel function that is formed on the TFT substrate of an AMLCD and in which no additional elements are required in the pixel circuit to enable the touch panel operation. Pixels are arranged into groups forming drive electrode and sense electrode segments wherein the size and shape of each segment may be designed to optimize the touch panel sensitivity. However, the touch panel is still susceptible to electrical interference from the display and this results in a limit to the SNR and hence the reliability that can be achieved. A means of integrating a touch panel function into an LCD to give reliable operation and without sacrificing the aperture ratio of the display is therefore sought.

### SUMMARY OF THE INVENTION

This invention relates to an integrated touch panel and liquid crystal display device which overcomes the aforementioned limitations of the prior art and provides a thin, lightweight module with reliable operation. In its most general form, the invention includes a projected (mutual) capacitance type touch panel and active matrix liquid crystal display. The touch panel further includes an array of drive and sense electrodes, a drive circuit and a sense circuit. The display further includes a row scanning circuit, a data driving circuit and a matrix of pixels which is spatially aligned with the touch panel electrode array.

The display is arranged to advantageously operate with low noise such that electrical interference generated by the display and received by the touch panel is substantially eliminated. Specifically, each pixel in the display matrix is arranged to receive a pair of differential voltage signals from the display data driver circuit wherein the sum of the individual voltages is a constant value and the difference is representative of the image data—i.e. of the intensity of light to be transmitted by the pixel. As a result, the display image data can be written with no net charge transferred to the touch panel from the display via the parasitic coupling capacitances formed between them. The electronic noise in the touch panel is therefore minimized and the reliability of the touch panel operation is improved.

According to an aspect of the invention, a touch panel and display device is provided which includes a projected capacitance type touch panel; and a display, the display including a plurality of pixels each including a pixel circuit having differential data inputs.

In accordance with another aspect, the display includes a data driver circuit configured to provide pairs of differential voltage signals to the differential data inputs of each of the pixel circuits.

According to another aspect, the differential voltage signals in each pair have a sum which is a constant value and a difference representative of image data to be presented by the pixel circuit which receives the pair of differential voltage signals.

According to still another aspect, a polarity of the pairs of differential voltage signals provided to the pixel circuits is periodically reversed.

In accordance with another aspect, the touch panel includes: a touch panel electrode array including an array of drive electrodes and an array of sense electrodes; a drive circuit which supplies a voltage excitation signal to the drive electrodes; and a sense circuit configured to sense coupling capacitance between the sense electrodes and the drive electrodes based on the voltage excitation signal.

According to yet another aspect, the plurality of pixels are arranged in a matrix spatially aligned with the touch panel electrode array.

According to still another aspect, each pixel circuit is arranged so as to have a first half and a second half which are symmetrical and which each include a corresponding one of the differential data inputs.

In accordance with still another aspect, each pixel circuit includes: a first switch transistor; a second switch transistor; a first storage capacitor; a second storage capacitor; a first capacitive liquid crystal element; and a second capacitive liquid crystal element; a drain terminal of the first switch transistor is connected to a first terminal of the first storage capacitor and a first terminal of the first liquid crystal element; a drain terminal of the second switch transistor is connected to a first terminal of the second storage capacitor and a first terminal of the second liquid crystal element; a second terminal of the first liquid crystal element and a second terminal of the second liquid crystal element are connected together; a gate addressing line is connected to gate terminals of both the first switch transistor and second switch transistor; a first source addressing line is connected to a source terminal of the first switch transistor and a second source addressing line is connected to a source terminal of the second switch transistor; and the second terminal of the first storage capacitor and the second terminal of the second storage capacitor are connected to a common electrode line; and the first terminal of the first liquid crystal element and the first terminal of the second liquid crystal element respectively represent the differential data inputs of the pixel circuit.

According to another aspect, the touch panel electrode array is formed on substrate and the plurality of pixels are formed on a different substrate.

In accordance with still another aspect, the plurality of pixels include in-plane switching type liquid crystal materials.

In yet another aspect, each pixel circuit includes differential data inputs represented by inter-digitated first and second electrodes.

According to another aspect, the touch panel electrode array is formed on a top surface of a counter substrate included in the display.

According to yet another aspect, each pixel circuit includes: a first switch transistor; a second switch transistor; a first capacitive liquid crystal element; a second capacitive liquid crystal element; and a storage capacitor; a drain terminal of the first switch transistor is connected to a first terminal of the first liquid crystal element and a first terminal of the storage capacitor; a drain terminal of the second switch transistor is connected to a first terminal of the second liquid crystal element and a second terminal of the storage capacitor; a second terminal of the first liquid crystal element and a second terminal of the second liquid crystal element are connected together such that a series combination of the first and second liquid crystal elements is in parallel with the storage capacitor; a gate addressing line is connected to gate terminals of both the first switch transistor and second switch transistor; a first source addressing line is connected to a source terminal of the first switch transistor and a second source addressing line is connected to a source terminal of the second switch transistor; and the first terminal of the first liquid crystal element and the first terminal of the second liquid crystal element respectively represent the differential data inputs of the pixel circuit.

In accordance with another aspect, the plurality of pixels are arranged in a matrix, adjacent pixels within a given row of the matrix share a source line, and two gate lines are provided for each row of pixels in the display.

According to another aspect, the device includes a first substrate on which display electronic layers are formed, the display electronic layers including thin film transistors which are part of the pixel circuits; and a second substrate on which touch panel electronic layers are formed, the touch panel electronic layers including a touch panel electrode array having sense electrodes and drive electrodes which are part of the projected capacitance type touch panel, wherein the first substrate and the second substrate are arranged opposite each other with the display electronic layers and the touch panel electronic layers facing one another and separated by a layer of liquid crystal material.

According to still another aspect, the sense electrodes and drive electrodes function both as part of the touch panel, and as part of the display as counter electrodes.

In accordance with another aspect, the sense electrodes and the drive electrodes are patterned in a single layer.

According to another aspect, the sense electrodes and the drive electrodes are aligned with the plurality of pixels.

According to another aspect, the sense electrodes and drive electrodes in the touch panel electronic layers are formed by groups of pixel counter electrode segments serving as pixel counter electrodes in relation to the display electronic layers formed on the first substrate.

According to still another aspect, the pixel counter electrode segments in a given group are patterned as individual segments.

In accordance with another aspect, the pixel counter electrode segments in a given group are patterned to form one continuous area.

According to another aspect, the electrical connections to the touch panel electrode array are made to the first substrate, and the pixel circuits include switch transistors operative in a sensing function in combination with the touch panel electrode array.

In accordance with another aspect, a source line operative in the display to provide image data to a pixel circuit during a display period is operative to provide sensor data from the touch panel electrode array during a sensing period.

According to another aspect, each pixel circuit includes: a first switch transistor; a second switch transistor; a first capacitive liquid crystal element; a second capacitive liquid crystal element; a first storage capacitor; a second storage capacitor; and a sensor switch transistor; wherein a drain terminal of the first switch transistor is connected to a first terminal of the first liquid crystal element and a first terminal of the first storage capacitor; a drain terminal of the second switch transistor is connected to a first terminal of the second liquid crystal element and a first terminal of the second storage capacitor; a second terminal of the first liquid crystal element and a second terminal of the second liquid crystal element are connected together at a pixel common electrode node; and a second terminal of the first storage capacitor and a second terminal of the second storage capacitor are connected together at a sensing node; and wherein the sensing node is connected to a drain terminal of the sensor switch transistor, a source terminal of which is connected to either of two source addressing lines and a gate terminal of which is connected to a sensor select addressing line.

In accordance with another aspect, each pixel circuit includes: a first switch transistor; a second switch transistor; a first capacitive liquid crystal element; a second capacitive liquid crystal element; a first storage capacitor; a second storage capacitor; a sensor amplifier transistor; and a sensor select transistor; wherein a drain terminal of the first switch transistor is connected to a first terminal of the first liquid crystal element and a first terminal of the first storage capacitor; a drain terminal of the second switch transistor is connected to a first terminal of the second liquid crystal element and a first terminal of the second storage capacitor; a second terminal of the first liquid crystal element and a second terminal of the second liquid crystal element are connected together at a pixel common electrode node; and a second terminal of the first storage capacitor and a second terminal of the second storage capacitor are connected together at a sensing node; wherein the sensing node is connected to a gate terminal of the sensor amplifier transistor, a source terminal of which is connected to a drain terminal of the sensor select transistor, and a drain terminal of which is connected to a sensor select addressing line; and wherein a gate terminal of the sensor select transistor is connected to the sensor select addressing line and a source terminal of the sensor select transistor is connected to either of two source addressing lines.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF DRAWINGS

In the annexed drawings, like references indicate like parts or features:

FIG. 1 shows conventional art: a surface capacitance sensor arrangement

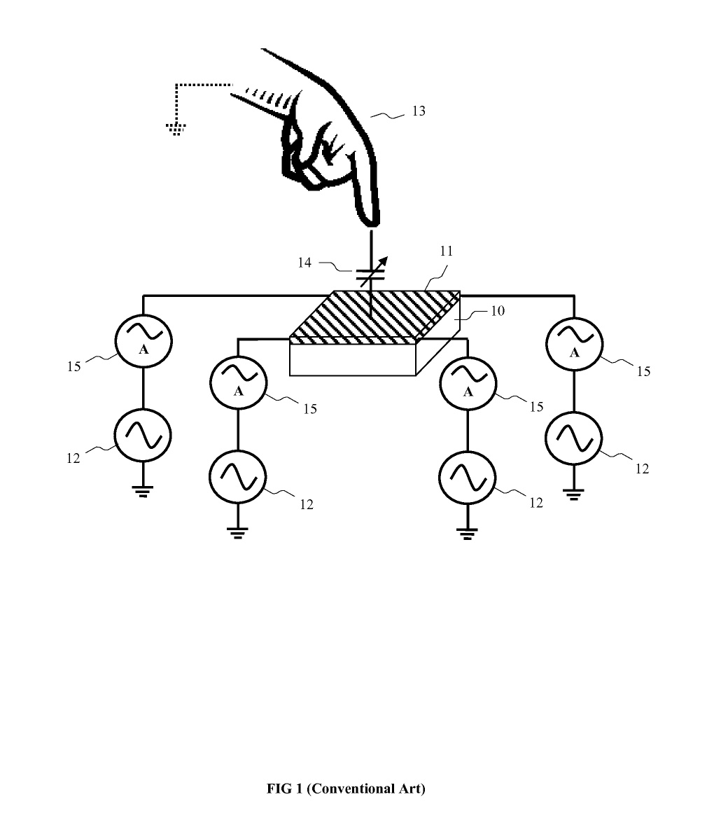

FIG. 2 shows conventional art: a projected capacitance sensor arrangement

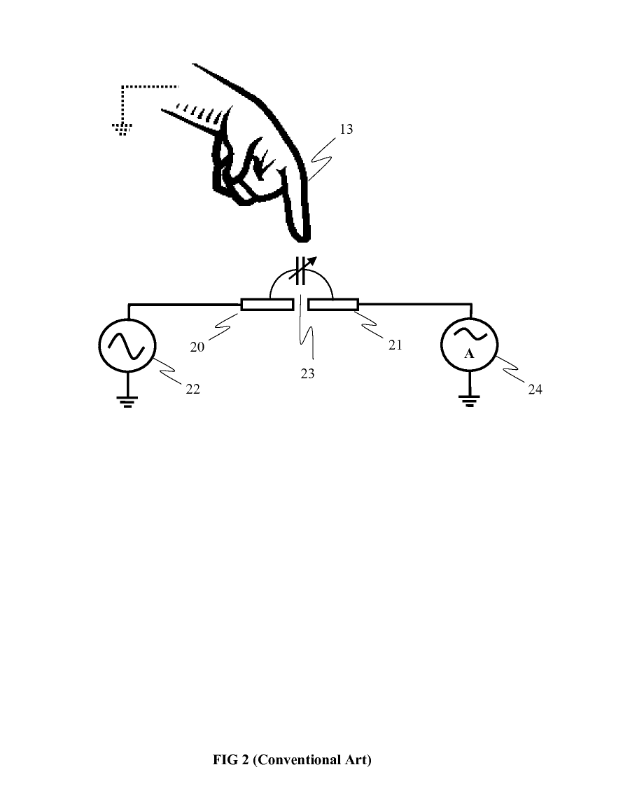

FIG. 3 shows a block diagram of the first embodiment of this invention

FIG. 4 shows a schematic diagram of a display pixel circuit in accordance with the first embodiment of the invention

FIG. 5 shows a cross-section diagram of a display pixel in accordance with the first embodiment of the invention

FIG. 6 shows a waveform diagram illustrating the operation of a display in accordance with the first embodiment of the invention

FIG. 7 shows the pixel electrode structure of a pixel in accordance with the second embodiment of the invention

FIG. 8 shows the construction of a display and touch panel device in accordance with the third embodiment of the invention

FIG. 9 shows a schematic diagram of a display pixel circuit in accordance with the fourth embodiment of the invention

FIG. 10 shows a schematic diagram of display pixel circuits in accordance with the fifth embodiment of the invention

FIG. 11 shows a waveform diagram illustrating the operation of a display in accordance with the fifth embodiment of the invention

FIG. 12 shows the cross-section of a display and touch panel device in accordance with the sixth embodiment of the invention

FIG. 13A shows the cross-section of a display and touch panel device in accordance with the seventh embodiment of the invention

FIG. 13B shows the plan view of the counter substrate of a display and touch panel device in accordance with the seventh embodiment of the invention

FIG. 14 shows the detail of the electrode pattern on the counter substrate of a display and touch panel device in accordance with the seventh embodiment of the invention

FIG. 15 shows a waveform diagram illustrating the operation of a display in accordance with the seventh embodiment of the invention

FIG. 16 shows a plan view of the counter substrate of a display and touch panel device in accordance with the eighth embodiment of the invention

FIG. 17A shows the thin-film transistor (TFT) substrate of a display and touch panel device in accordance with the eighth embodiment of the invention

FIG. 17B shows the detail of the pixel matrix and common addressing line connections of a display and touch panel device in accordance with the eighth embodiment of the invention

FIG. 18 shows a waveform diagram illustrating the operation of a display in accordance with the eighth embodiment of the invention

FIG. 19 shows a schematic diagram of a display pixel circuit used as a sense pixel in accordance with the ninth embodiment of the invention

FIG. 20 shows a waveform diagram illustrating the operation of a display in accordance with the ninth embodiment of the invention

FIG. 21 shows a schematic diagram of a display pixel circuit used as a sense pixel in accordance with the tenth embodiment of the invention

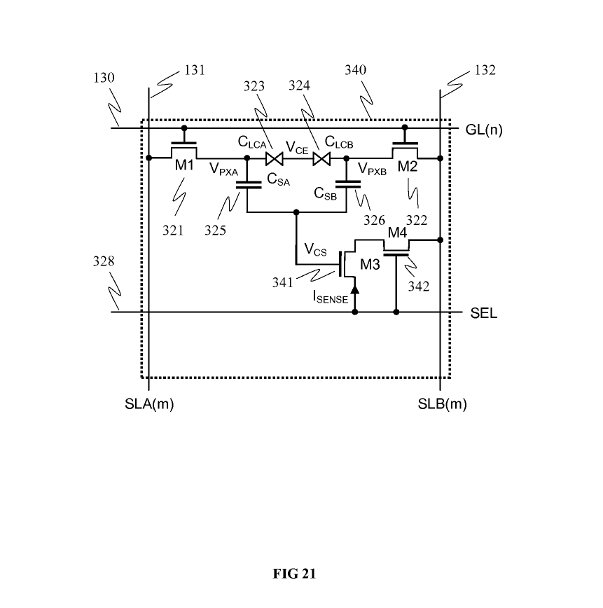

### DESCRIPTION OF REFERENCE NUMERALS

10 Substrate
11 Surface capacitance sensor electrode
12 Voltage source
13 Finger or other conductive object
14 Coupling capacitor
15 Current measurement apparatus
20 Drive electrode
21 Sense electrode
22 Voltage source
23 Coupling capacitor
24 Current measurement apparatus
27 First dynamic capacitor
28 Second dynamic capacitor
100 Touch panel
101 Active matrix liquid crystal display
102 Touch panel electrode array
103 Drive electrodes
104 Sense electrodes
105 Transparent substrate
106 Touch panel controller
107 Drive circuit
108 Sense circuit
109 Touch panel interface circuit
110 First transparent substrate
111 Pixel matrix
112 Second transparent substrate
113 Display controller
114 Row scanning circuit
115 Data driver circuit
116 Display interface circuit
119 Host controller
120 Low-noise pixel circuit
121 First switch transistor
122 Second switch transistor
123 First storage capacitor
124 Second storage capacitor
125 First liquid crystal element
126 Second liquid crystal element
130 Gate addressing line
131 First source addressing line
132 Second source addressing line
133 Common electrode addressing line
140 First pixel electrode
141 Second pixel electrode
142 Counter pixel electrode
143 Liquid crystal material
150 Combined AMLCD and touch panel device
151 Display counter substrate with touch panel electrode array
152 On-cell touch panel electrode array
153 On-cell drive electrodes
154 On-cell sense electrodes
160 Pixel circuit
161 First switch transistor
162 Second switch transistor
163 First liquid crystal element
164 Second liquid crystal element
165 Storage capacitor
200 Counter substrate
201 Display electronic layers
202 Touch panel electronic layers
203 Liquid crystal material
210 Base-coat layer
211 Sense electrode layer
212 First insulating layer
213 Drive electrode layer
214 Second insulating layer
215 Display common electrode layer
216 Liquid crystal alignment layer
220 Touch panel electrode layers
221 Bridge layer
222 Insulating layer
223 Touch panel electrode layer
230 Drive electrode
231 Sense electrode
232 Bridge connection
240 Diamond element of touch panel electrode
241 Display pixels
301 Drive electrode groups
302 Sense electrode groups
305 Drive pixel groups
306 Sense pixel groups
307 Driving common electrode addressing line
308 Sensing common electrode addressing line
320 Display pixel used as a sense pixel
321 First switch transistor
322 Second switch transistor
323 First liquid crystal element
324 Second liquid crystal element
325 First storage capacitor
326 Second storage capacitor
327 Sensor switch transistor
328 Sensor select addressing line
340 Display pixel circuit used as a sense pixel
341 Sensor amplifier transistor
342 Sensor select transistor

### DETAILED DESCRIPTION OF INVENTION

This invention describes a touch panel and liquid crystal display device which overcomes the aforementioned limitations of the prior art and provides a thin, lightweight module with reliable operation. The display is arranged to advantageously operate with low noise such that electrical interference generated by the display and received by the touch panel is substantially eliminated.

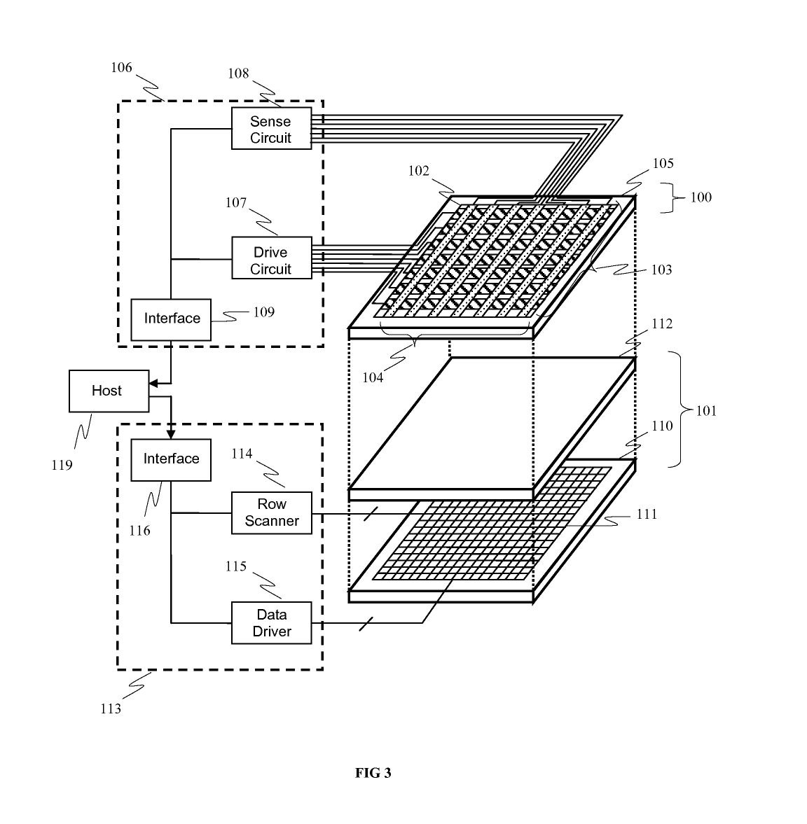

A first and most general embodiment of the invention, shown in FIG. 3, includes a projected (mutual) capacitance type touch panel 100 and active matrix liquid crystal display (AMLCD) 101. The touch panel is of a well-known construction and further includes an array 102 of drive electrodes 103 and sense electrodes 104 formed on a transparent substrate 105 and a touch panel controller 106 formed by a drive circuit 107, a sense circuit 108 and an interface circuit 109. The set of drive electrodes 103 and set of sense electrodes 104 may be formed in a transparent material, such as indium-tin-oxide (ITO) or conductive polymer, and fabricated by standard manufacturing techniques, such as photolithographic or printing methods. Touch location data captured by the touch panel is transferred to a host device 119. The AMLCD is of a well-known general construction and further includes a first transparent substrate 110 (commonly referred to as the display thin-film transistor (TFT) substrate), on which a pixel matrix 111 is formed and a second transparent substrate 112 (commonly referred to as the display counter substrate) opposing the first. The display pixel matrix 111 and the touch panel electrode array 102 are spatially aligned such that the touch panel electrode array 102 completely overlaps the display pixel matrix 111. A display controller 113 is also provided to control the operation of the AMLCD and includes a row scanning circuit 114, a data driver circuit 115 and an interface circuit 116. The display controller may be a separate integrated circuit or at least some elements may be integrated onto the TFT substrate 110. The host controller 119 supplies the image data to be displayed by the AMLCD.

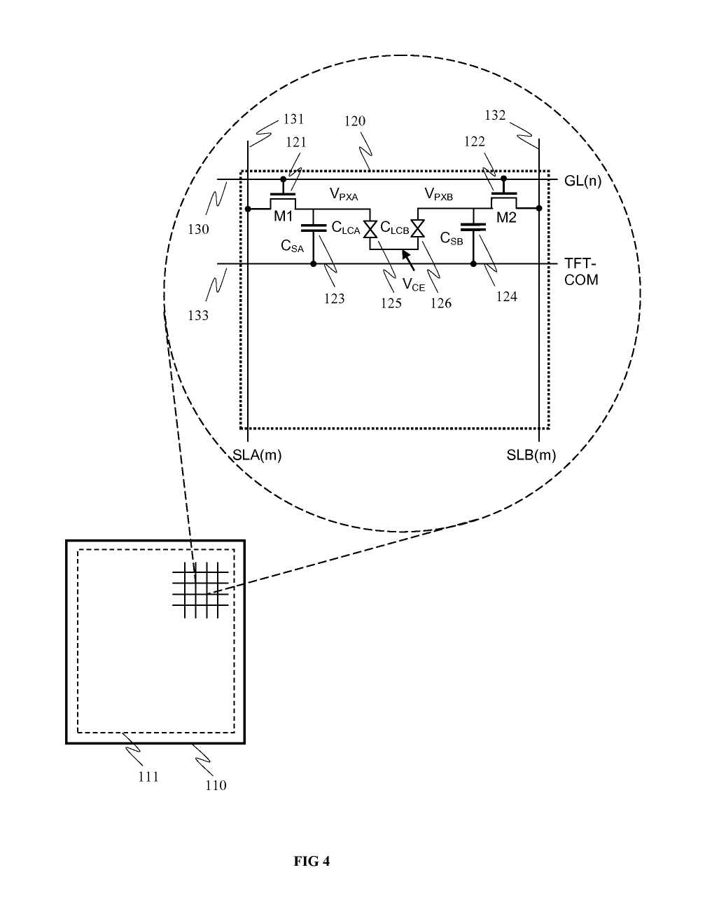

The pixel matrix of the AMLCD 101 is formed by an array of low-noise pixel circuits 120 as shown in FIG. 4. A low-noise pixel circuit 120 includes: a first switch transistor (M1) 121; a second switch transistor (M2) 122; a first storage capacitor (CSA) 123; a second storage capacitor (CSB) 124; a first capacitive liquid crystal element (CLCA) 125; and a second capacitive liquid crystal element (CLCB) 126. The first and second switch transistors 121, 122 may be thin-film transistors, for example amorphous silicon or polycrystalline silicon thin-film field-effect transistors. The drain terminal of the first switch transistor 121 is connected to a first terminal of the first storage capacitor 123 and a first terminal of the first liquid crystal element 125. Similarly, the drain terminal of the second switch transistor 122 is connected to a first terminal of the second storage capacitor 124 and a first terminal of the second liquid crystal element 126. The second terminal of the first liquid crystal element 125 and the second terminal of the second liquid crystal element 126 are connected together. A gate addressing line (GL) 130 is connected to the gate terminals of both the first switch transistor 121 and second switch transistor 122. A first source addressing line (SLA) 131 is connected to the source terminal of the first switch transistor 121 and a second source addressing line (SLB) 132 is connected to the source terminal of the second switch transistor 122. The second terminal of the first storage capacitor 123 and the second terminal of the second storage capacitor 124 are connected to a common electrode line (TFTCOM) 133.

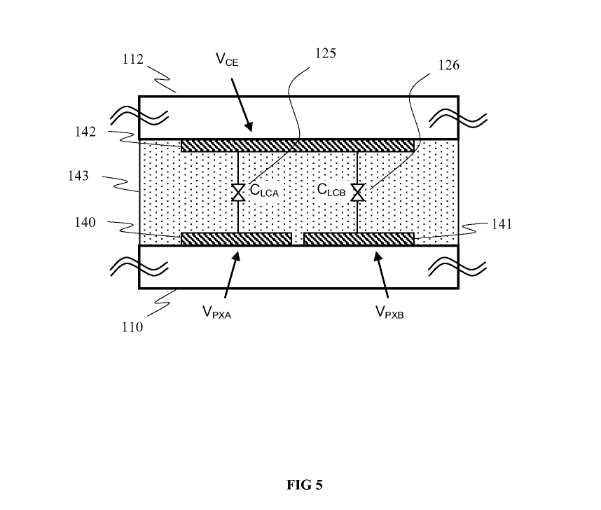

The first switch transistor 121, first storage capacitor 123 and first liquid crystal element 125 form a first half of the pixel circuit 120 and the second switch transistor 122, second storage capacitor 124 and second liquid crystal element 126 form a second half of the pixel circuit 120. The first half and second half of the pixel circuit are arranged to be symmetrical such that the layout of all elements of one half mirrors the layout of all elements in the second half. A cross-section of one possible arrangement of the pixel circuit 120 suitable for use with a liquid crystal material responsive to vertical electric fields is shown in FIG. 5. In this arrangement, the pixel circuit is formed on the TFT substrate 110 and includes a first pixel electrode 140 which acts as a first terminal of the first liquid crystal element 125 and a second pixel electrode 141 which acts as a first terminal of the second liquid crystal element 126. A counter electrode segment 142 is formed on the counter substrate 112 which is separated from the TFT substrate by a layer of liquid crystal material 143. The first and second pixel electrodes 140,141 and pixel counter electrode segment 142 may be formed in a transparent material, such as indium-tin-oxide (ITO) or conductive polymer, and fabricated by standard manufacturing techniques, such as photolithographic or printing methods. The counter electrode segment 142 is spatially aligned with the first pixel electrode 140 and second pixel electrode 141 and forms the second terminal of both the first liquid crystal element 125 and second liquid crystal element 126. Since the layout of the first and second half of the pixel circuit is symmetrical, the voltage at the counter electrode segment 142, V_{CE}, is the average of the voltages of the first and second pixel electrodes, V_{PXA} and V_{PXB} respectively:

V_{CE}=(V_{PXA}+V_{PXB})/2

Referring again to FIG. 3, the operation of a projected (mutual) capacitance type touch panel 100 is well-known and is now briefly described. During a single sense period, one drive electrode of the set of drive electrodes 103 in the electrode array 102 is driven with a voltage excitation signal supplied by the drive circuit 107. The mutual coupling capacitance of the intersection between this active drive electrode and a sense electrode in the set of sense electrodes 104 generates a signal on the sense electrode in proportion to the magnitude of the coupling capacitance. The sense circuit 108 samples the generated signal and creates a digitized representation of the coupling capacitance. In subsequent sense periods voltage excitation signals are supplied to each of the other drive electrodes in turn such that, in one frame of operation, a digitized representation of the coupling capacitance of each intersection in the array is captured. When a conductive object, such as a finger is brought into proximity to the electrode array 102, the mutual coupling capacitance of the intersections opposite the object is modified. These changes in coupling capacitance may be detected by the interface circuit 109 and the co-ordinates of the location(s) of touch input in each frame period, if detected, are passed to the host controller 119.

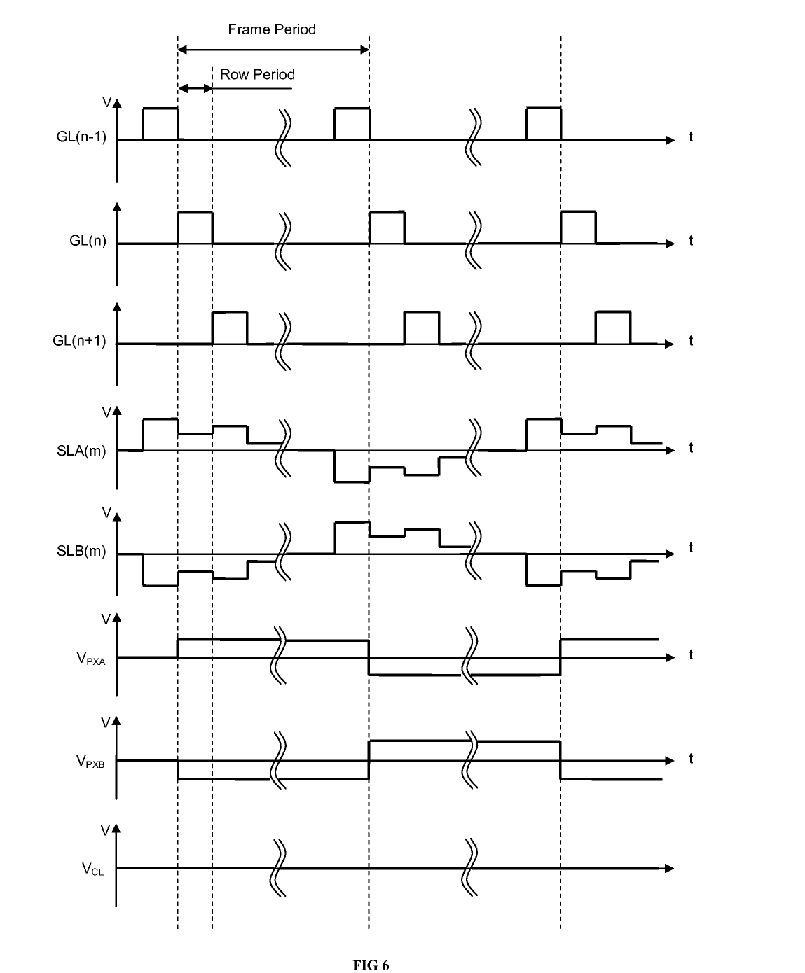

The general operation of an AMLCD 101 is well-known and not described here in detail. However, as is now described, during the pixel data writing operation the pixels being addressed are arranged to receive a pair of differential voltage signals from the display data driver circuit 115. These differential voltage signals are chosen such that the sum of the individual voltages is a constant value, such as zero, and the difference is representative of the image data. A waveform diagram illustrating the data writing operation for a single pixel circuit 120 in an AMLCD 101 is shown in FIG. 6. During a single row period, the row scanner circuit 114 applies a pulse signal to a gate line 130 (e.g., GL(n−1) in the matrix such that when the gate line 130 is made high at the start of the row period the first and second switch transistors 121,122 of each pixel circuit 120 in the selected row are turned on. The data driver circuit 115 now applies differential voltage signals to all the first and second source lines 131, 132 (e.g., SLA(m), SLB(m)) in the array and the pixel electrodes 140, 141 (representing the differential data inputs) are charged or discharged via the switch transistors to the source line voltages. At the end of the row period the gate line is made low and the first and second switch transistors 121,122 are turned off thus storing the pixel voltages, V_{PXA}, and V_{PXB}, on the pixel electrodes 140,141 until the gate line is selected again in the subsequent frame. All gate lines (e.g., GL(n), GL(n+1), etc.) are scanned and data is written to all pixels (i.e., pixel circuits 120) in the pixel matrix 111 during one frame of operation.

As is well-known, the polarity of the voltage signal applied across the liquid crystal layer in an AMLCD must periodically be reversed in a process known as “inversion” in order to avoid degradation of the liquid crystal material. In the present embodiment of this invention, the polarity of the voltage signals applied to the first source lines 131 in any particular frame is the opposite of the polarity of the voltage signals applied in the previous frame. Similarly, the polarity of the voltage signals applied to the second source lines 132 in any particular frame is the opposite of the polarity of the voltage signals applied in the previous frame. As a result, the potential difference across the liquid crystal elements is reversed in sign every frame and degradation of the liquid crystal material is avoided.

The magnitude of the voltage signals generated by the data driver circuit 115 are proportional to the image data to be displayed by the corresponding pixel whilst the polarity (sign) of the voltage signals applied to the first source lines 131 is the opposite of the polarity of the voltage signals applied to the second source lines 132. Accordingly, since the layout of the first and second half of the pixel circuit is symmetrical as described above, the voltage V_{CE} of the pixel counter electrode 142 remains unchanged at zero. This combination of differential driving method and pixel circuit arrangement therefore has the significant advantage that there is no net injection of charge due to any parasitic capacitive coupling between the display pixel matrix 111 and the touch panel electrode array 102. Reliable operation of the touch panel is therefore possible even when the touch panel substrate 105 and the second display substrate 112 are very thin and the separation distance between the pixel matrix 111 and electrode array 102 is small.

The driving method described above where all pixels in one row are written simultaneously is intended to illustrate the operation of the low-noise pixel circuit with differential inputs. Other well-known AMLCD driving methods such as, but not limited to, source-shared driving techniques, multi-phase driving techniques and driving techniques employing driver circuits integrated onto the TFT substrate 110 may be used as an alternative.

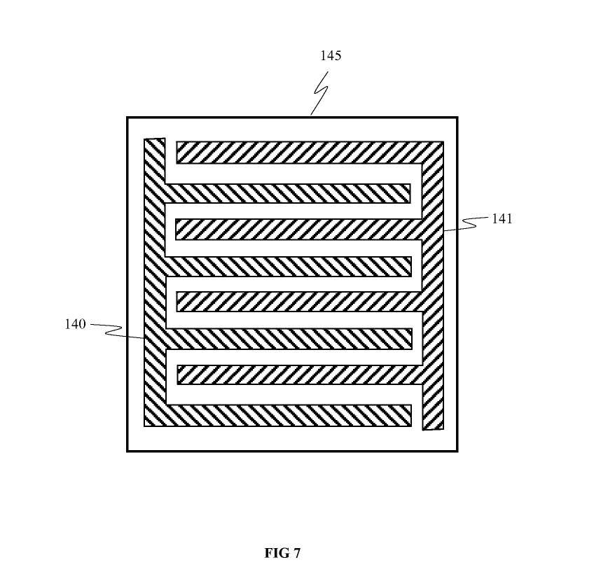

In a second embodiment of the invention, the pixel circuit of the first embodiment is modified to be suitable for use with in-plane switching type liquid crystal materials. In such a pixel circuit 145, the first and second pixel electrodes 140, 141 form inter-digitated structures, as shown in the layout diagram of FIG. 7. The operation and general construction of in-plane switching type liquid crystal materials is well known, for example as disclosed in “Development of Super-TFT-LCDs With In-Plane Switching Display Mode”, M Ohta et al pp 707-710, Asia Display '95 (1995), and is not described here in detail. There is no common electrode in the pixel circuit 145 and parasitic capacitive coupling exists directly between the touch panel electrode array 102 and the pixel electrodes 140, 141. However, since the charge injected by coupling from one pixel electrode will be exactly cancelled by the charge removed by coupling from the other pixel electrode, there is no net injection of charge onto the touch panel electrode array and reliable operation of the touch panel is possible.

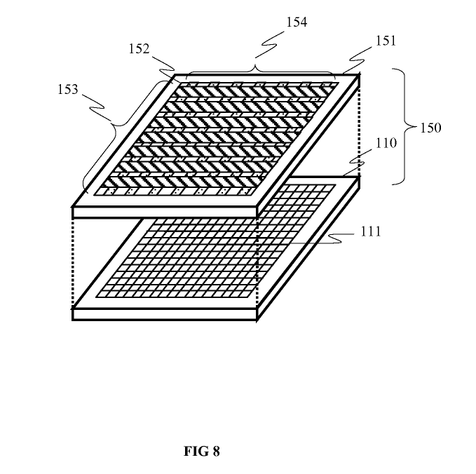

In a third embodiment of the invention, shown in FIG. 8, a combined AMLCD and touch panel device 150 includes a touch panel electrode array 152 formed on top surface of the display counter substrate 151 in an arrangement commonly referred to as an “on-cell” type touch panel. The aforementioned pixel counter electrode segments 142 (not shown in FIG. 8) are formed on the bottom surface of the counter substrate 151. The touch panel electrode array 152 including a plurality of drive electrodes 153 and a plurality of sense electrodes 154 is formed on the top surface of the counter substrate 151. The construction and operation of the touch panel electrode array 152 is similar to that described in the previous embodiment. An advantage of this embodiment is that a separate touch panel substrate is no longer required and the design of the display and touch panel module may be made thinner and lighter. Although the parasitic capacitive coupling between the touch panel electrode array and the display pixel matrix is increased as the distance between them is now decreased, the operation of the low-noise pixel circuit prevents any electrical interference from the display affecting the touch panel operation.

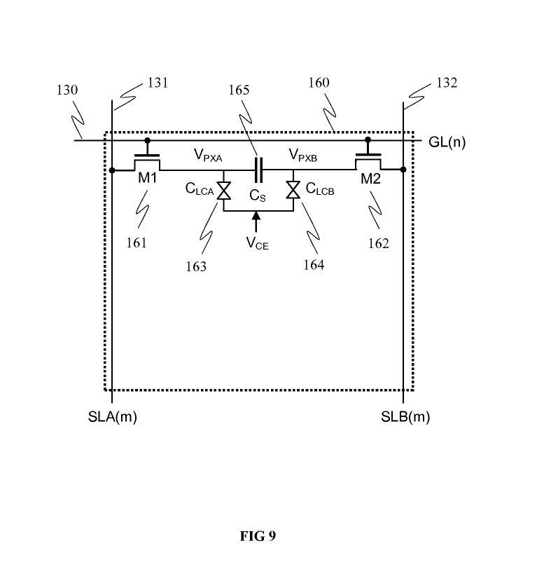

In a fourth embodiment of the invention, the low-noise pixel circuit of any of the previous embodiments may be modified to increase the aperture ratio of the display. The pixel circuit 160 of this embodiment, shown in FIG. 9, comprises: a first switch transistor (M1) 161; a second switch transistor (M2) 162; a first capacitive liquid crystal element (CLCA) 163; a second capacitive liquid crystal element (CLCB) 164; and a storage capacitor 165. The drain terminal of the first switch transistor 161 is connected to a first terminal of the first liquid crystal element 163 and a first terminal of the storage capacitor (CS) 165. The drain terminal of the second switch transistor 162 is connected to a first terminal of the second liquid crystal element 164 and a second terminal of the storage capacitor 165. The second terminal of the first liquid crystal element 163 and the second terminal of the second liquid crystal element 164 are connected together such that the series combination of the liquid crystal elements is in parallel with the storage capacitor 165. The first switch transistor 161, first liquid crystal element 163 and first terminal of the storage capacitor 165 form a first half of the pixel circuit. The second switch transistor 162, second liquid crystal element 164 and second terminal of the storage capacitor 165 form a second half of the pixel circuit which is arranged with a layout symmetrical to the first half. The gate addressing line 130 and first and second source addressing lines 131, 132 are connected to the first and second switch transistors 161, 162 in a similar arrangement to that of the previous embodiments. The operation of the pixel circuit is therefore similar to that described for the first embodiment. An advantage of this embodiment is that only a single storage capacitor is used and the common electrode line (TFTCOM) of the previous embodiments may be removed. As a result, the display aperture ratio may be increased leading to either an increase in the brightness of the display or, alternatively, a reduction in the power consumption of the display backlight for a given brightness.

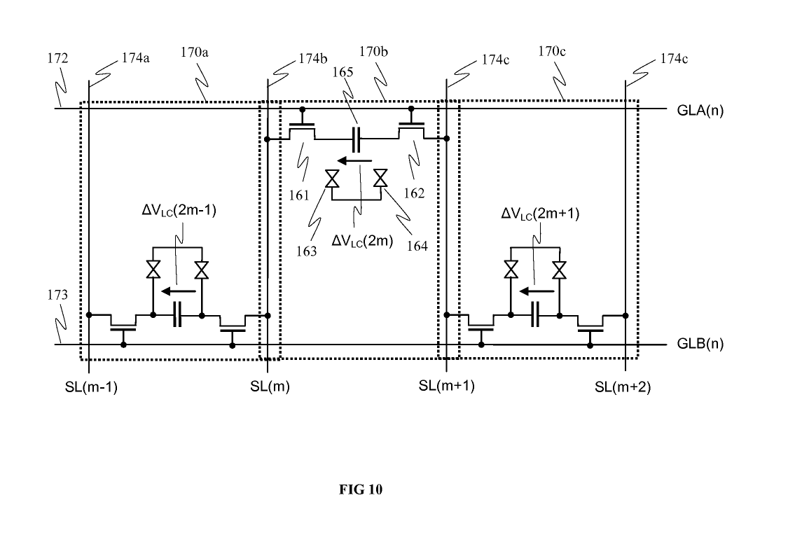

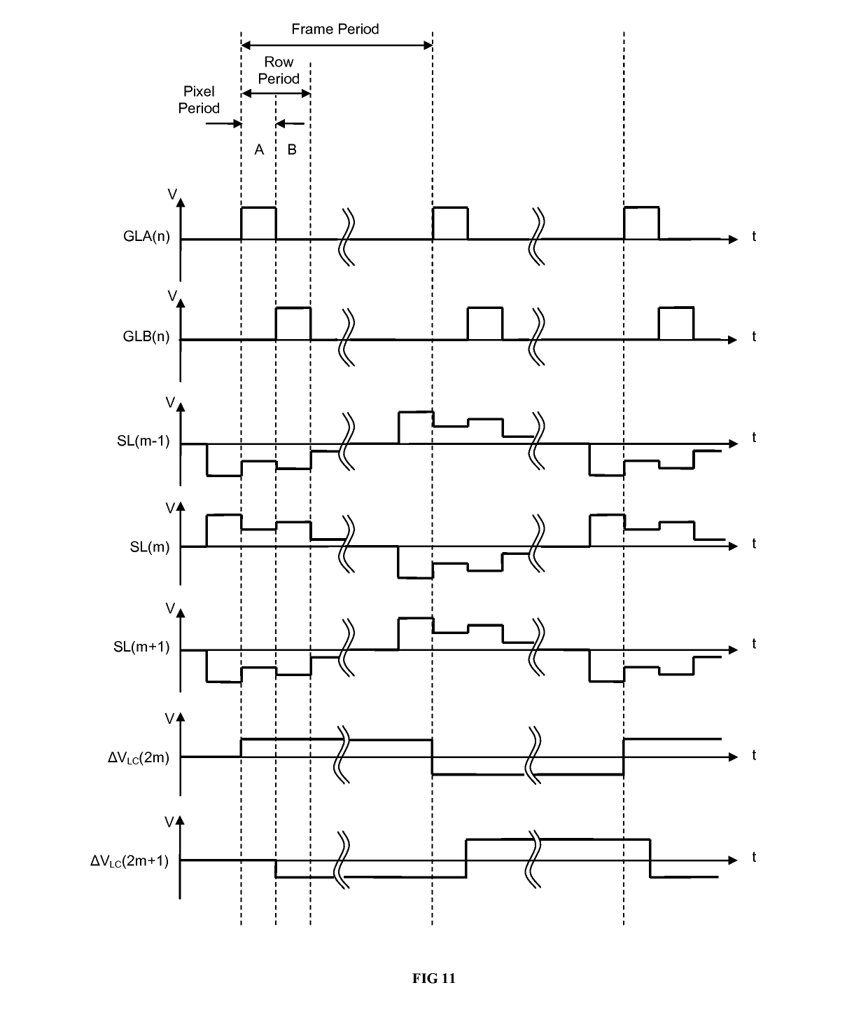

In a fifth and preferred embodiment of the invention, each source line of the low-noise pixel circuit of any of the previous embodiments is shared between two pixel circuits to further increase the aperture ratio of the display. The pixel circuit of the present embodiment may, for example, be of a similar type to that of the third embodiment but, as shown in FIG. 10, each source line is shared between adjacent pixels and two gate address lines are provided for each row of pixels. A first gate address line (GLA) 172 is connected to the gate terminal of the switch transistors 161, 162 of all odd numbered pixels in a row, and a second gate address line (GLB) 173 is connected to the gate terminal of the switch transistors of all even numbered pixels in a row. The operation of a display including a matrix of pixels arranged in such a manner is now described with reference to the schematic diagram of FIG. 10 and the waveform diagram of FIG. 11. One row period of the display operation is divided into a first pixel period “A” and a second pixel period “B”. During the first pixel period “A”, the first gate address line (GLA) 172 is made high under control of the row scanner circuit 114 (FIG. 3) and the switch transistors of all pixels connected to that address line—for example, the odd numbered pixels—are turned on. Simultaneously, voltage signals corresponding to the data to be written to the selected pixels are applied to the source lines by the data driver circuit 115 in accordance with the differential driving method described previously. For example, data voltage signals with negative polarity may be applied to the odd numbered source lines SL(m−1) 174a and SL(m+1) 174c, data voltage signals with a positive polarity may be applied to the even numbered source lines SL(m) 174b and SL(m+2) 174d and the pair of data voltage signals applied to any one pixel are of equal magnitude but opposite sign. At the end of the first pixel period, the first gate address line (GLA) 172 is made low and the switch transistors of all pixels connected to that address line are turned off thus storing the differential data voltage, ΔV_{LC}(2m), that corresponds to the image data in each pixel. During the second pixel period “B”, which immediately follows the first pixel period “A”, the second gate address line (GLB) 173 is made high and image data is written to the pixels connected to that address line—for example, the even numbered pixels—in a process similar to that of the first pixel period. Accordingly, at the end of one row period, the differential data voltage, ΔV_{LC}(2m+1), that corresponds to the image data has been written to all pixels in the selected row. At the end of the row period, the next row is selected by the row scanner circuit 114 and image data is written to that row in a process similar to that described above. During one frame period of the display operation each row in turn is selected by the row scanner circuit 114 such that at the end of the frame period image data has been written to all pixels in the pixel matrix. In order to reduce power consumption caused by charging and discharging the capacitances associated with the source addressing lines, individual source lines 174 may receive voltage signals of the same polarity during one frame. However, in order to prevent degradation of the liquid crystal material, the polarity of the differential data voltages, ΔV_{LC}(2m), ΔV_{LC}(2m+1), must be periodically reversed. Accordingly, in a subsequent frame period voltage signals corresponding to the image data to be written to the selected pixels are supplied by the data driver circuit 115 whereby the source lines 174 are driven with an opposite polarity to that of the previous frame i.e. the source lines driven with a positive polarity in the previous frame are driven with a negative polarity in the present frame and the source lines driven with a negative polarity in the previous frame are driven with a positive polarity in the present frame.

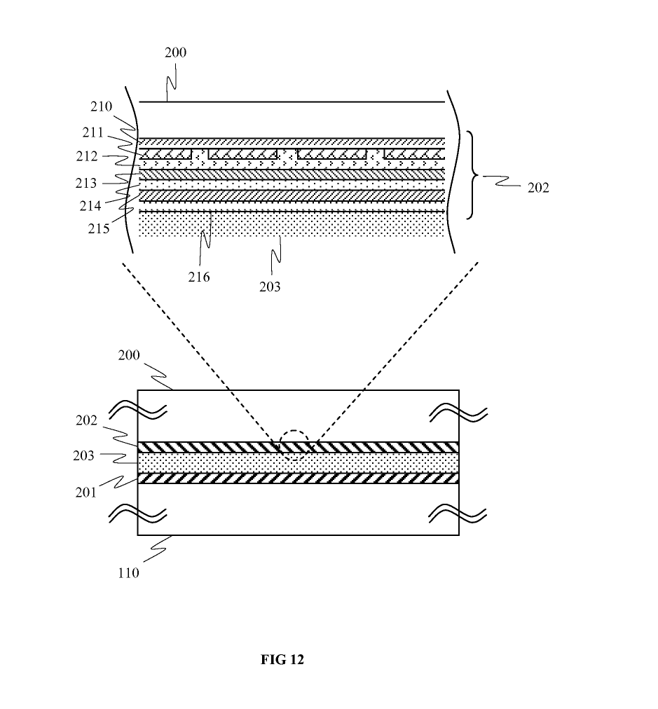

In a sixth embodiment of the invention, shown in FIG. 12, a combined AMLCD and touch panel device includes a touch panel electrode array formed on the bottom surface of the display counter substrate in an arrangement commonly referred to as an “in-cell” type touch panel. The device of the present embodiment includes a first transparent substrate 110 (the TFT substrate) on which display electronic layers 201 are formed and a second transparent substrate 200 (the counter substrate) on which touch panel electronic layers 202 are formed. All electronic layers are manufactured using standard photo-lithographic, deposition and etching methods well-known in the field of AMLCDs. The first and second transparent substrates are arranged opposite each other with the display electronic layers 201 and touch panel electronic layers 202 facing one another and separated by a layer of liquid crystal material 203. The touch panel electronic layers 202 include the sense electrodes 211 and drive electrodes 213 which form the touch panel electrode array. The sense electrodes may be formed on top of an insulating base-coat layer 210 and separated from the drive electrodes 213 by a first insulating layer 212. If the AMLCD utilises a vertical-type liquid crystal material, the touch panel electronic layers 202 may include a liquid crystal alignment layer 216 and a display common electrode 215 which is separated from the touch panel drive electrodes 213 by a second insulating layer 214 and may extend across the entire matrix of pixels or be patterned into floating islands as previously described. Alternatively, if the AMLCD utilises a horizontal type liquid crystal material, the display common electrode 215 may be omitted and the thickness of the insulating layer 214 may be chosen to be sufficient to prevent the touch panel drive electrodes from influencing the operation of the display. The drive electrodes 213, sense electrodes 211 and display common electrode 215 may be made of a transparent conductive material such as, for example, Indium-Tin Oxide. The display electronic layers 201 include the differential pixel circuit of the present invention and other electronic components necessary to control the operation of the AMLCD. The second (counter) transparent substrate 200 may be of sufficient thickness to minimize the difficulty of handling during manufacture and assembly and then, since there are no electronic layers on its top surface, reduced in thickness after the device has been assembled, for example, by etching of the substrate. Accordingly, an advantage of the present embodiment is that the thickness and weight of the device may be reduced compared to the previous embodiments.

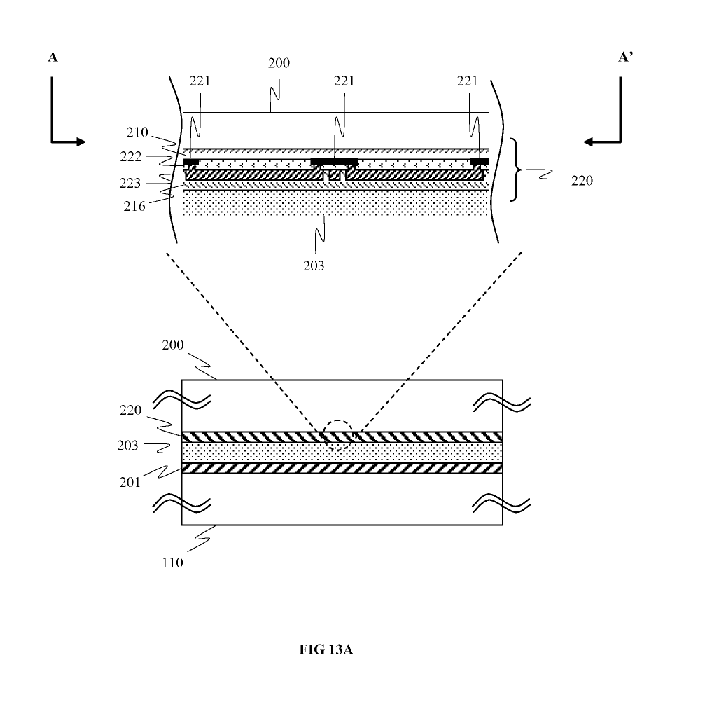

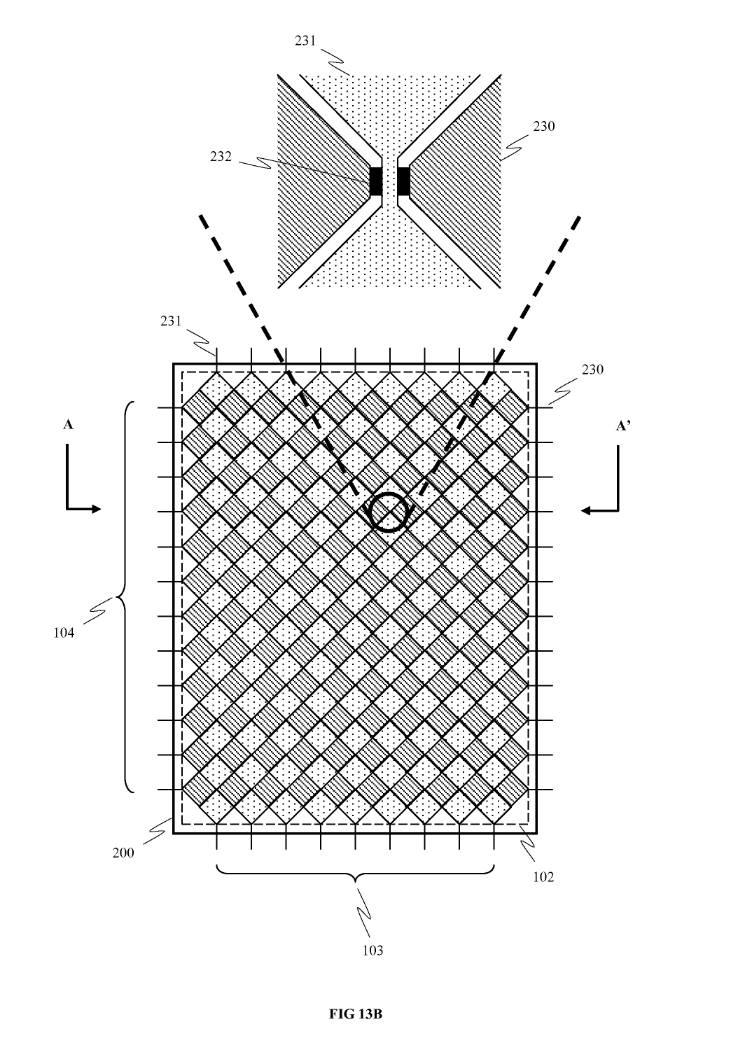

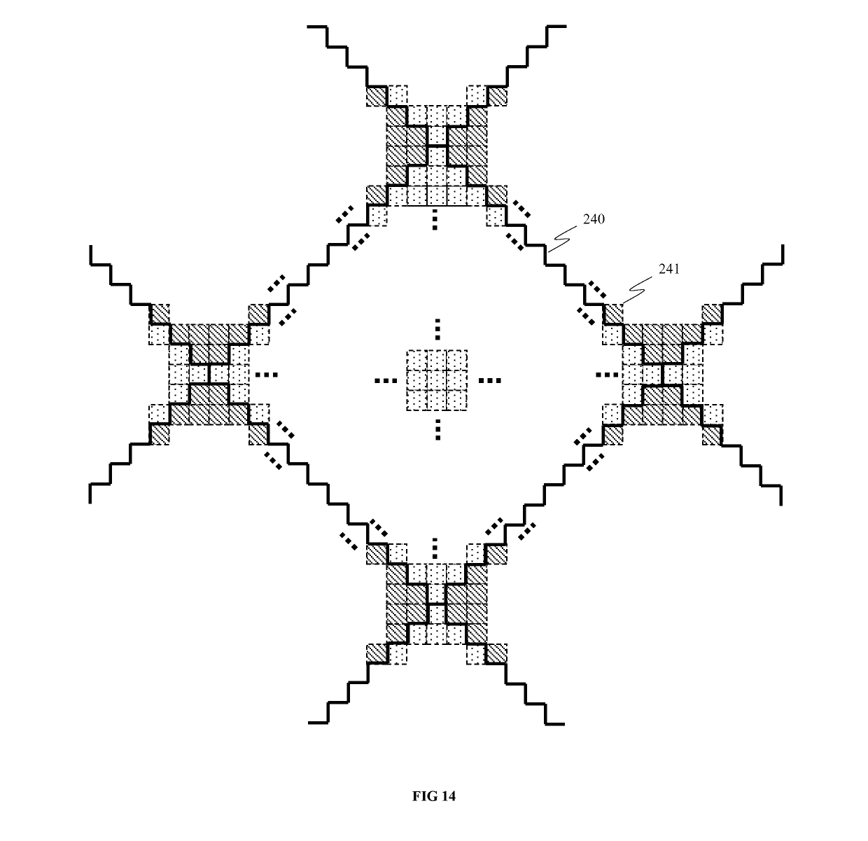

In a seventh embodiment of the invention, shown in a cross-section view in FIG. 13A and in a plan view in FIG. 13B, the touch panel electrodes forming the touch panel electrode array also function as the display common electrode. As in the previous embodiment, the touch panel of the present embodiment is an in-cell type arrangement with the touch panel electrode layers 220 formed on the second (counter) transparent substrate 200 using standard photo-lithographic, deposition and etching processes well-known in the manufacture of AMLCDs. The touch panel electrode layers 220 may include: a base-coat 210 formed directly on the substrate; a bridge layer 221; an insulating layer 222; a touch panel electrode layer 223 and a liquid crystal alignment layer 216. In order for the touch panel electrodes in the touch panel electrode layer 223 to function both as part of the touch panel and the display (as counter electrodes), the electrodes must be formed in a single layer such that there is a uniform distance between the touch panel electrodes and the display pixel electrodes. Accordingly, the set of drive electrodes 104 and set of sense electrodes 103 that constitute the touch panel electrode array 102 are both formed in the touch panel electrode layer 223 in a transparent conductive material such as, for example, Indium-Tin Oxide (ITO). Each drive electrode 230 or sense electrode 231 may be patterned in any suitable manner that allows their formation in a single layer such as, for example, the diamond pattern shown in FIG. 13B. In such a pattern, the individual diamonds 240 of one set of electrodes—for example, the set of sense electrodes 103—are connected together in the sensor electrode layer 223 and the individual diamonds of the other set of electrodes—for example, the set of drive electrodes 104—are connected together by bridge connections 232 formed in the bridge layer 221. The electrodes may also be patterned to match the display pixel matrix, as illustrated in FIG. 14, whereby the edges of each individual diamond 240 follow the outline of and are aligned with the pixels 241 of the display pixel matrix. The display pixels are formed in the display electronics layer 201 and are of the type described in the fourth embodiment of this invention (or the fifth embodiment when based on the fourth embodiment) wherein the storage capacitor is connected between each half of the differential pixel and in parallel with the liquid crystal elements.

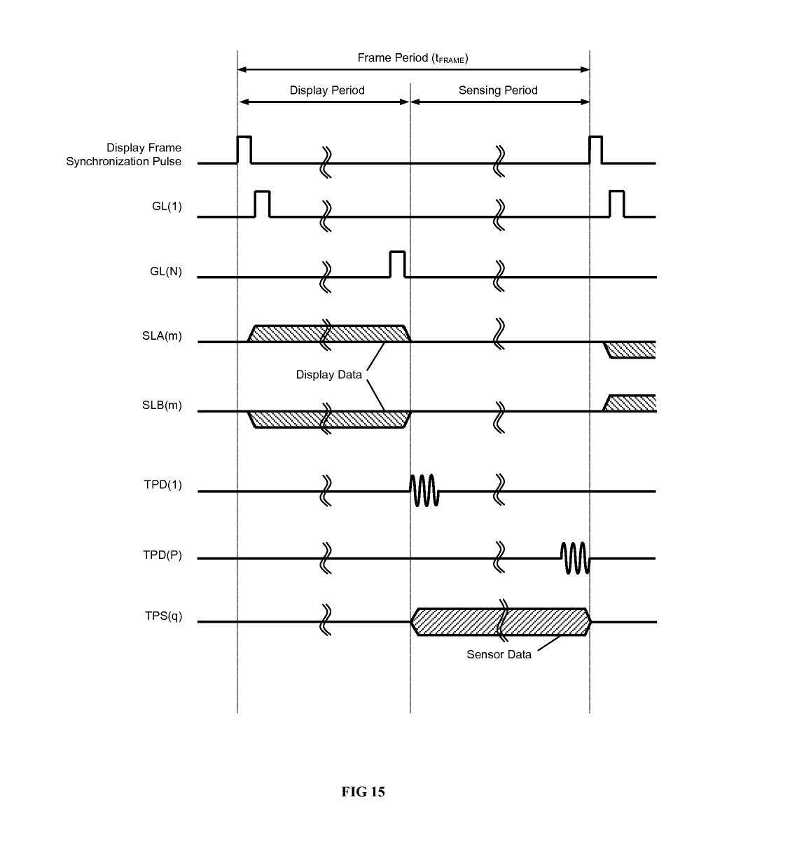

In order to allow the touch panel electrodes 230,231 to function both as an element of the touch panel and as an element of the display, the touch panel and display functions may be operated by means of time sharing. For example, one method of time sharing is to divide each frame of operation of the device into a first period for writing image data to the display and a second period for measuring touch data from the touch panel. The operation of an AMLCD and touch panel device using such a time sharing method is now described with reference to the waveform diagram of FIG. 15. During the first (display) period all of the P drive electrodes 230 {TPD(1) . . . TPD(P)} in the set of drive electrodes 104 and all of the Q sense electrodes 231 {TPS(1) . . . TPS(Q)} in the set of sense electrodes 103 are held at a constant voltage, such as the system ground potential, by the touch panel controller 106. Image data may then be written to each pixel in the display pixel matrix as previously described whereby each gate electrode {GL(1) . . . GL(N)} is activated in turn and differential voltage signals are written to the display source lines {SLA(1) . . . SLA(M), SLB(1) . . . SLB(M)}. During the second (sensing) period the capacitance associated with each intersection in the touch panel electrode array is measured in a manner similar to that previously described. Each of the drive electrodes 230 is selected in turn by the touch panel drive circuit 107 and a driven with a voltage excitation signal and the touch panel sense circuit 108 measures the corresponding signals generated on each of the sense electrodes 231. Due to the capacitive coupling between the touch panel electrodes and the display pixel electrodes via the liquid crystal capacitor, the voltage signals present on the touch panel electrodes 230, 231 during the second period will cause a change in voltage of the nodes V_{PXA} and V_{PXB} of the display pixels. However, since the layout of the display pixel is symmetrical, the change in voltage of each half of the pixel is identical, ΔV_{PXA}=ΔV_{PXB}, and the potential difference, V_{PXA}−V_{PXB}, across the liquid crystal elements C_{LCA}, and C_{LCB} which defines the image data does not change. Accordingly, the touch panel operation does not disturb or otherwise influence the displayed image. Further, since the storage capacitor, C_{S}, is connected between the two pixel electrodes in each pixel, V_{PXA} and V_{PXB}, and not between the pixel electrode and a common addressing line as in a conventional AMCLD, the capacitance of the nodes V_{PXA} and V_{PXB} is negligibly small. As a result, the capacitances of the liquid crystal elements C_{LCA}, and C_{LCB}, which are dependent on the image data, do not disturb or otherwise influence the touch panel measurements.

In each of the embodiments described above mechanical connections must be made to both the substrate on which the display electronic layers are formed and to the substrate on which the touch panel electronic layers are formed. In conventional LCD and touch panel manufacturing processes, such mechanical connections are typically made using flexible printed circuits (FPC) which are bonded to the respective transparent substrates using an electrically conductive adhesive such as an anisotropic conductive film (ACF). In order to reduce the thickness, increase the physical robustness and reduce the cost of manufacture of the device, it is desirable to combine the display FPC and the touch panel FPC such that only a single mechanical connection to the device is required.

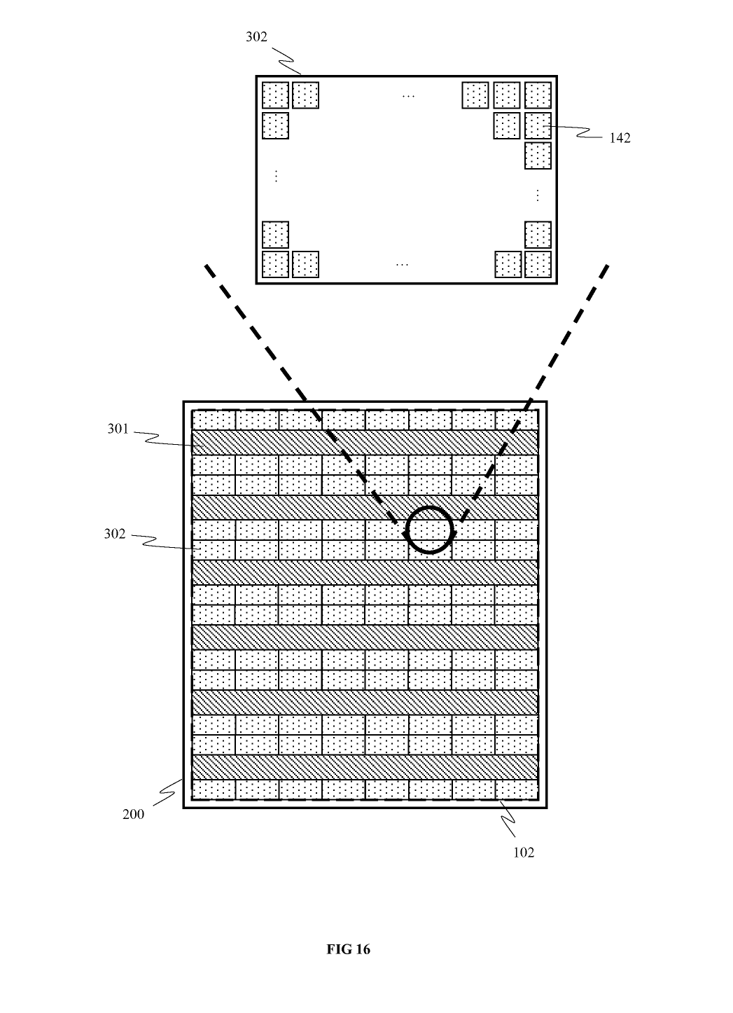

According to an eighth embodiment of the present invention, an AMLCD is combined with a touch panel device in an in-cell type arrangement wherein only a single mechanical connection to the device is required. As with the previously described in-cell type touch panel arrangements, a touch panel electrode array 102 is formed on the bottom surface of the counter substrate 200. However, in the present embodiment, although the display pixel circuit is of a type similar to that described in the first embodiment, the drive and sense electrodes are formed by groups of pixel counter electrode segments 142. FIG. 16 illustrates how these drive electrode groups 301 and sense electrode groups 302 are arranged across the electrode array 102 and how the pixel counter electrode segments 142 are grouped together to form a single electrode group, such as a sense electrode group 302. In an alternative arrangement, the pixel electrode segments forming a single electrode group may be patterned to form one continuous area extending across the area of the electrode group (as opposed to the individual pixel segments shown). The mutual coupling capacitance between each drive electrode group and each sense electrode group is changed by the proximity of a conductive object, such as a finger, in a manner similar to that between each drive and sense electrode in the matrix type arrangements of the previously described touch panel electrode arrays.

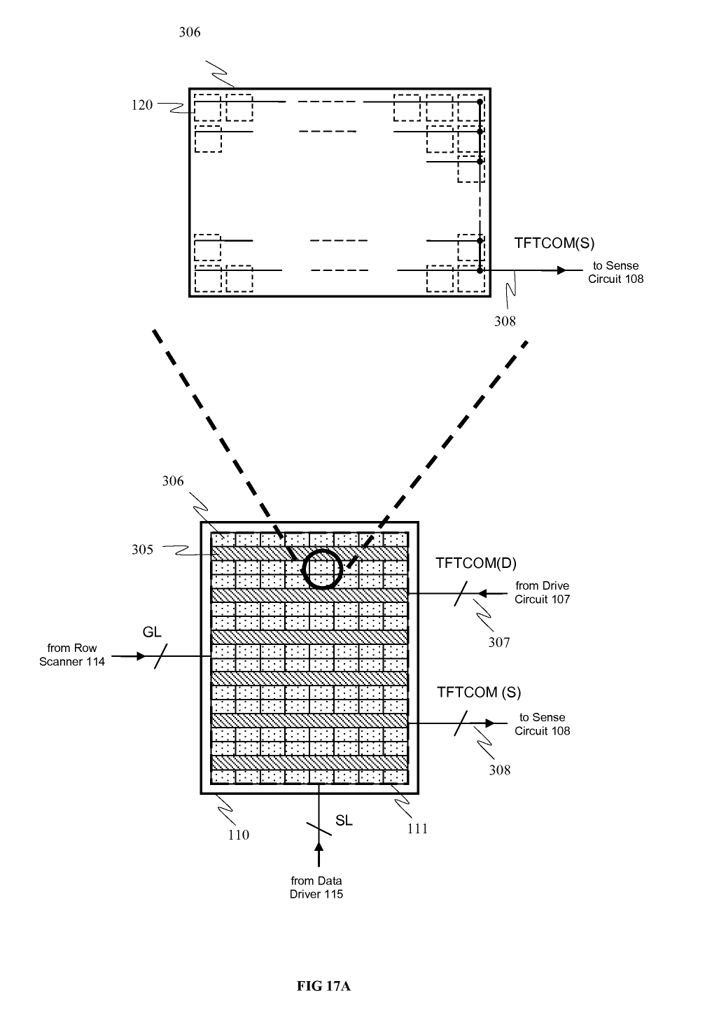

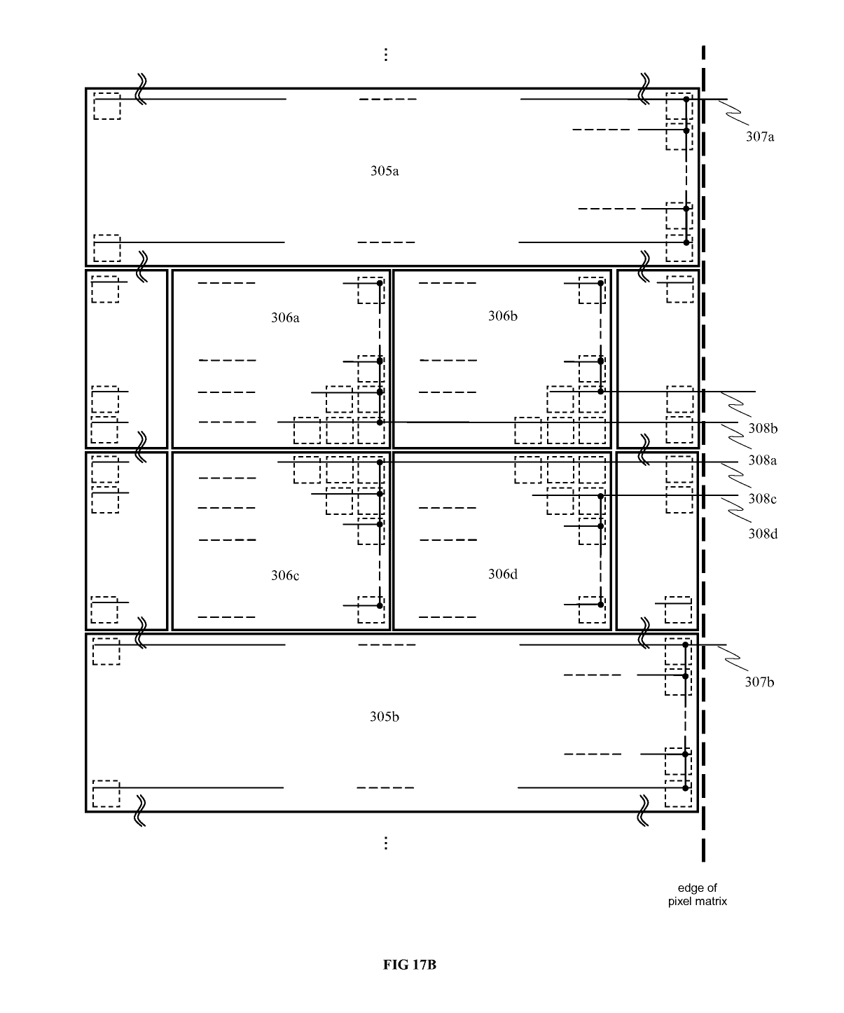

A pixel in the display pixel matrix 111—for example the pixel 120 of the first embodiment—containing a counter electrode segment 142 that is a member of a sense electrode group 302 is designated a sense pixel and a pixel containing a counter electrode segment 142 that is a member of a drive electrode group 301 is designated a drive pixel. As shown in FIG. 17A, the drive pixels are arranged in drive pixel groups 305 corresponding to the location of the drive electrode groups 301 and the sense pixels are arranged in sense pixel groups 306 corresponding to the location of the sense electrode groups 302. The common electrode addressing lines 133 (FIG. 4) of the drive pixel groups 305 form driving common electrode addressing lines 307 and those of the sense pixel groups 306 form sensing common electrode addressing lines 308. All the common electrode addressing lines, TFTCOM(D) 307, of one drive pixel group 305 are electrically connected together and all the common electrode addressing lines, TFTCOM(S) 308, of one sense electrode group 306 are electrically connected together. For example, when the common electrode addressing lines form rows in the pixel matrix, additional wiring may be provided in the column direction—in at least one column of pixels in the pixel group—to make these connections. In order to connect from the sense circuit 108 to the sense pixel groups in the center of the matrix (i.e. without a border to the matrix periphery), the common electrode addressing lines 308 of these pixel groups must pass through adjacent pixel groups. For example, as shown in FIG. 17B, the sensing common electrode addressing line 308a of the sense pixel group 306a in the center of the matrix must pass through the adjacent sense pixel group 306b and other sense pixel groups in the same row (not shown) in order to be accessible at the edge of the pixel matrix. Some pixels in the adjacent sense pixel group 306b will therefore contribute an error signal to the signal generated during the sense period on the sensing common electrode addressing line 308a. However, the proportion of pixels outside any sense pixel group that contribute to the error signal is small and does not significantly influence the capacitance measurement. Further, if the sensing common electrode addressing line 308a passes through the adjacent sense pixel group 306b at the furthest distance from the drive pixel group 305a, as shown, the magnitude of the error signal generated will be minimized.

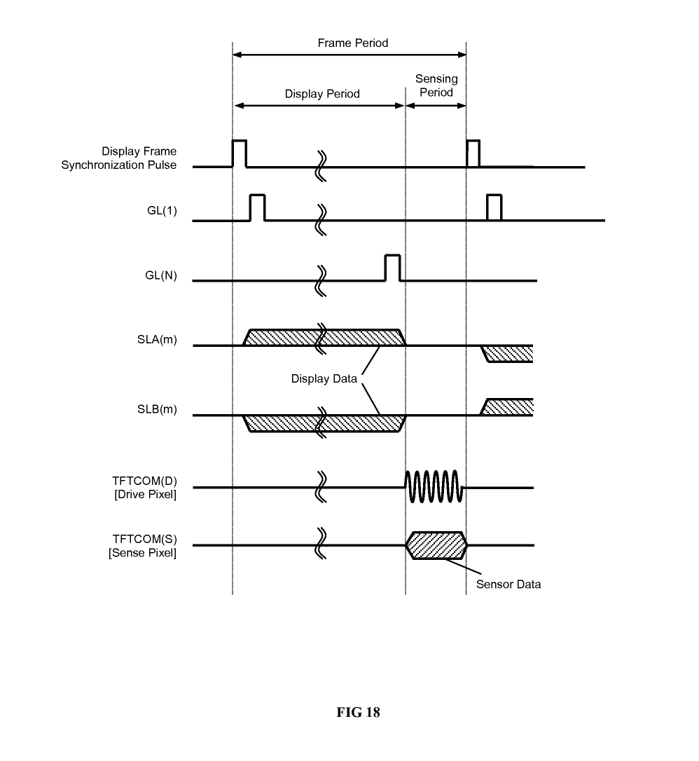

The operation of a display and touch panel device according to the present embodiment is now described with reference to the waveform diagram of FIG. 18. In a first driving period of one frame of operation of the device display data is written to each pixel in the pixel matrix according to the differential driving method previously described. In a second sensing period the touch panel data is measured by and read-out from the electrode array as now described. As previously described—in the description of the first embodiment of this invention and shown in FIG. 4—the common electrode addressing lines are capacitively coupled to each pixel electrode 140, 141, via the storage capacitors (C_{SA}, C_{SB}) 123, 124. Also, the capacitance of the storage capacitors is much greater than the total of the parasitic capacitances of the first or second pixel electrode, C_{PA} or C_{PB}, i.e. C_{SA}, C_{SB}>>C_{PA}, C_{PB}. Thus, when the first and second switch transistors 121, 122 are switched off, changes in voltage of the first pixel electrode 140, ΔV_{PXA}, and of the second pixel electrode 141, ΔV_{PXB}, are substantially equal to the change in voltage of the common electrode addressing line, ΔV_{TFTCOM}. The relationship between the changes in voltage of the pixel electrodes and common electrode addressing line is given by:

ΔV_{PXA}=ΔV_{TFTCOM}·C_{S}/(C_{S}+C_{PA})=ΔV_{TFTCOM}

ΔV_{PXB}=ΔV_{TFTCOM}·C_{S}/(C_{S}+C_{PB})=ΔV_{TFTCOM}

The change in voltage of the pixel counter electrode segment 142 is therefore equal to the change in voltage of the common electrode addressing line as demonstrated by the following equation:

ΔV_{CE}=(ΔV_{PXA}+ΔV_{PXB})/2=ΔV_{TFTCOM}

Any drive signal applied to the driving common electrode addressing lines 307 of the drive pixel groups 305 will therefore be transferred to the counter electrode segments 142 of the drive electrode groups 301. Further, any change in the voltage of the counter electrode segments 142 of the sense electrode groups 302 due to the drive signal will be transferred to the sensing common electrode addressing lines 308 of the adjacent sense pixel groups 306. Accordingly, during the sensing period, the pixel counter electrode segments of a drive electrode group 301 act together as a conventional drive electrode and the pixel electrode segments of a sense electrode group 302 act together as a conventional sense electrode and measurement may be made of their mutual capacitance. In such an arrangement, the touch controller drive circuit 107 applies drive signals to the driving common electrode addressing lines 307 and the touch controller sense circuit 108 is used to detect the signal generated on the sensing common electrode addressing lines 308. All signals for both the display and touch panel may therefore be applied through a single mechanical connection to the TFT substrate thus reducing the device thickness and manufacturing cost whilst improving the reliability and robustness.

In a preferred sensing method, all of the driving common electrode addressing lines 307 may be driven simultaneously and all of the sensing common addressing lines 308 may be sampled simultaneously. The capacitance associated with each intersection of drive electrode group and sense electrode group across the entire touch panel electrode array is therefore measured in one single operation. Advantageously, this minimizes the impact of the touch panel operation on the display operation or allows a higher measurement frequency of the touch panel. The driving common electrode lines 307 may also to be connected together thus reducing the number of connections required to be made to the device. Alternatively, to reduce the complexity and size of the touch controller sense circuit, each drive electrode group 301 may be driven in turn and only the sense electrode groups 302 adjacent to the active drive electrode group sampled.

Since the capacitance of the liquid crystal elements 125, 126—which varies with image data—does not influence the signal generated on the sensing common electrode addressing lines 308, the touch panel capacitance measurements are independent of the displayed image. In addition, there is no change in the voltage applied across the liquid crystal elements during the sensing period and hence no degradation or change of the display image is observed due to the touch panel operation. Further, if the parasitic capacitances of the pixel electrodes are well-matched as would be found in the aforementioned symmetrical layout, no change in the displayed image will be observed even if size of the storage capacitor is reduced. This may advantageously allow the aperture ratio of the display to be increased. However, a disadvantage of the present embodiment is that separate connecting wires to the device are required for each sense electrode group. When a large display is used, or where the size of the sense electrode group must be small to provide a high accuracy in the measurement of touch location, the number of connections that must be made becomes large. This is undesirable since these connections must be routed to a single mechanical connector and the area required for doing so is large, thus increasing the size of the device.

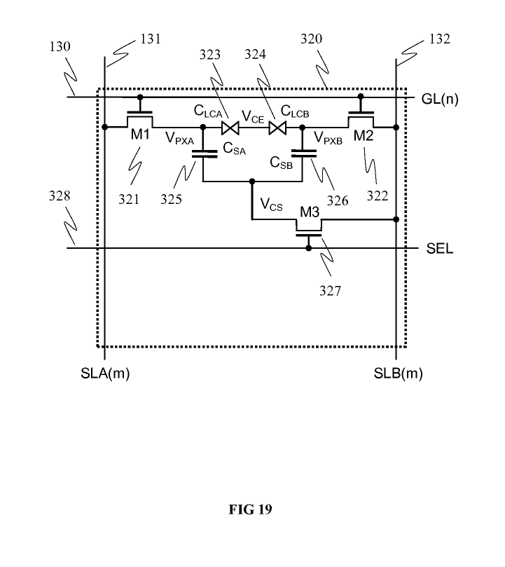

In order to reduce the number of connecting wires to the device and hence reduce its size, a ninth embodiment of the present invention includes an AMLCD and in-cell type touch panel device wherein electrical connections to the touch panel electrode array are made to the TFT substrate of the device and additional switch transistors for the sensing function are provided in the pixel circuits. The drive pixel circuit of the present embodiment may be similar to that of the eighth embodiment (and shown, for example, in FIG. 4) whereas a sense pixel circuit in accordance with the present embodiment is shown in FIG. 19. The sense pixel circuit 320 includes: a first switch transistor (M1) 321; a second switch transistor (M2) 322; a first capacitive liquid crystal element (CLCA) 323; a second capacitive liquid crystal element (CLCB) 324; a first storage capacitor (CSA) 325; a second storage capacitor (CSB) 326; and a sensor switch transistor (M3) 327. The drain terminal of the first switch transistor 321 is connected to a first terminal of the first liquid crystal element 323 (represented by the first pixel electrode 140), and a first terminal of the first storage capacitor (CSA) 325. The drain terminal of the second switch transistor 322 is connected to a first terminal of the second liquid crystal element 324 (represented by the second pixel electrode 141), and a first terminal of the second storage capacitor (CSB) 326. The second terminal of the first liquid crystal element 323 and the second terminal of the second liquid crystal element 324 are connected together at the pixel common electrode node, V_{CE}. The second terminal of the first storage capacitor 325 and the second terminal of the second storage capacitor 326 are connected together at a sensing node, V_{CS}. The sensing node is connected to the drain terminal of the sensor switch transistor (M3) 327, the source terminal of which is connected to either one of the source addressing lines 131, 132 and the gate terminal of which is connected to a sensor select addressing line (SEL) 328. The first switch transistor 321, first liquid crystal element 323 and first storage capacitor 325 form a first half of the pixel circuit. The second switch transistor 322, second liquid crystal element 324 and second storage capacitor 326 form a second half of the pixel circuit which is arranged with a layout symmetrical to the first half. As before, the first and second pixel electrodes 140, 141 are aligned with pixel counter electrode segments 142 formed on the counter substrate 200.

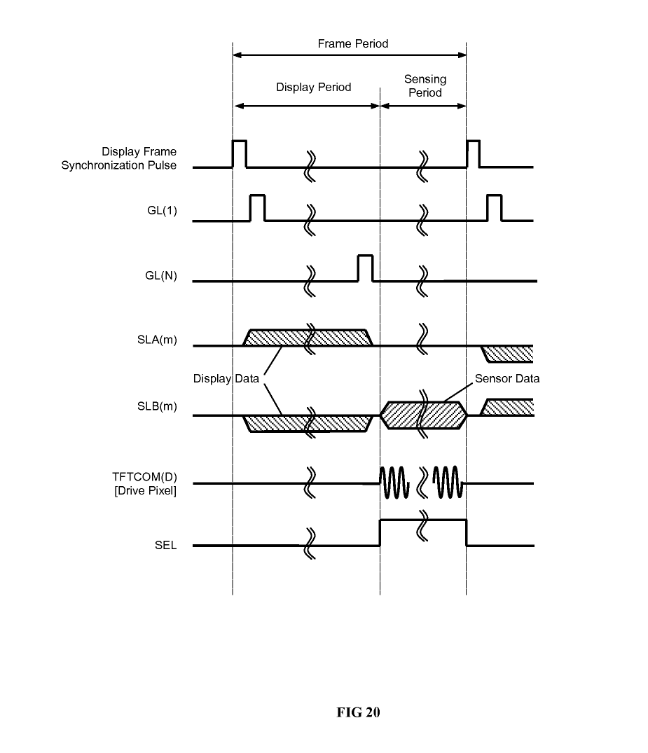

The operation of the sense pixel circuit is now described with reference to the waveform diagram of FIG. 20. In a first driving period of one frame of operation of the device display data is written to each pixel in the pixel matrix according to the differential driving method previously described. During this period, the source addressing lines are connected to the data driver circuit 115 of the display controller 113. In a second sensing period the source addressing lines are connected to the sense circuit 108 of the touch controller 106 and the touch panel data is measured by and read-out from the electrode array as now described. The sensing node is capacitively coupled to each pixel electrode 140, 141 via the storage capacitors (C_{SA}, C_{SB}) 325, 326 and further to the pixel counter electrode segment 142 via the liquid crystal elements 323, 324. Thus, when the first and second switch transistors 121, 122 are switched off and a drive signal is applied to the drive common electrode addressing lines 307, a voltage signal is generated on the pixel counter electrode segments of the sense electrode groups 302 and charge is injected onto the sensing node according to the mutual coupling capacitance between the drive electrode group 301 and the sense electrode group 302. Since the first and second halves of the pixel are symmetrical, the charge injected onto a sensing node, ΔQ_{CS}, via a corresponding pixel common electrode segment is given by:

$$\begin{matrix}Δ {Q}_{cs} = Δ {V}_{CE} \cdot [ {C}_{LCA} \cdot {C}_{SA} / ( {C}_{LCA} + {C}_{SA} ) + {C}_{LCB} \cdot {C}_{SB} / ( {C}_{LCB} + {C}_{SB} ) ] \\ = 2 \cdot Δ {V}_{CE} \cdot {C}_{LCA} \cdot {C}_{SA} / ( {C}_{LCA} + {C}_{SA} )\end{matrix}$$

The charge injected onto the sensing node is a function of the change in voltage of the counter electrode segment and hence of the mutual capacitance between the drive electrode group 301 and sense electrode group 302 being measured. When the sensor select line 328 is activated and the sensor switch transistor 327 is turned on, this injected charge may be transferred to the touch controller sense circuit 108 and measured.

In a preferred arrangement of the pixel counter electrode segments 142, all of the segments of a sense electrode group 302, are connected together. The charge injected onto the sensing node, ΔQ_{CS}, of every sense pixel in the corresponding sense pixel group 306 is therefore determined by the signal generated across the entire area of the electrode group (and not just a single pixel counter electrode segment). Accordingly, only one sensor switch transistor 327 is required for each sense electrode group 302. The sense switch transistor 327 may be omitted from all other sense pixels in the same sense pixel group 306 thus allowing the aperture ratio of the display to be increased. Further, the location of the sensor switch transistor 327 in each sense pixel group 306 may be different such that each sense pixel group with the same horizontal (row) location is connected to a different source line. Advantageously, the signal generated on each sense electrode group 302 in the electrode array may therefore be sampled simultaneously.

In an alternative arrangement of the present embodiment, the drive pixel circuit may also be formed in accordance with the pixel circuit shown in FIG. 19. In such an arrangement, the pixel counter electrode segments 142 of all of the drive pixels of a drive electrode group 301 may be connected together and only one switch transistor is required for each drive electrode group 301. The locations of the switch transistor in each drive pixel group 305 may be different such that each drive pixel group and each sense pixel group is connected to a different source line. In the operation of this arrangement, when the select signal, SEL, is made high during the sensing period, the drive signal is applied to those source lines connected to a drive pixel group 305 and the charge injected onto the source lines connected to each sense pixel group 306 may be measured.

A disadvantage of the present embodiment however is that the charge injected onto the sensing node during the sensing period is dependent on the capacitance of the liquid crystal element. Since this capacitance may change in accordance with the image data, the display operation may interfere with the correct operation of the touch panel. Further, the charge injected onto the sensing node may be small when compared to the noise associated with the parasitic capacitance and resistance of the source addressing lines. As a result the signal-to-noise ratio of the sense circuit will be small leading to inaccurate measurements of capacitance and incorrect operation of the touch panel.

According to a tenth embodiment of the present invention, a sense pixel circuit with amplification function is provided in order improve the accuracy of the capacitance measurement of the touch panel function and prevent any dependency on the display operation. Instead of the sensor switch transistor of the previous embodiment, the pixel circuit 340 of the present embodiment includes a sensor amplifier transistor (M3) 341 and a sensor select transistor (M4) 342. The sensor amplifier transistor 341 is arranged with its drain terminal connected to the sensor select addressing line 328, its gate terminal to the sensing node and its source terminal to the drain terminal of the sensor select transistor 342. The gate terminal of the sensor select transistor 342 is connected to the sensor select addressing line 328 and the source terminal to a source addressing line, such as the second source addressing line 132.

The operation of the sense pixel circuit of the present embodiment is similar to that of the previous embodiment. However, during the sensing period, the charge injected onto the sensing node, ΔQ_{CS}, causes a change in voltage of that node, ΔV_{CS}, in proportion to the total capacitance of the node. If the capacitance, C_{G}, of gate terminal of the sensor amplifier transistor 341 is much smaller than the capacitance of the storage capacitors 325, 326 (i.e. (C_{SA}, C_{SB}>>C_{G}) then the change in voltage of the sensing node will be equal to the change in voltage of the pixel counter electrode segment, ΔV_{CS}=ΔV_{CE}. When the select addressing line 328 is made active and brought to a high potential, the sensor select transistor 342 is turned on and the amplifier transistor is connected to the touch controller sense circuit 108 via the second source addressing line 132. A conductive path is now formed between the sensor select addressing line 328 and the sense circuit 108 and current, I_{SENSE}, flows along this path according to the voltage at the sensing node, V_{CS}, and hence to the mutual capacitance between the drive electrode group 301 and sense electrode group 302 being measured. Amplification of the sensed signal arises from the fact that this current, I_{SENSE}, may be several orders of magnitude greater than the current associated with the injection of charge onto the sensing node. As a result, the display image data does not affect the capacitance measurement and a high signal-to-noise ratio may be obtained in the sense circuit. The operation of the touch panel is therefore reliable and accurate.

Although the invention has been shown and described with respect to a certain embodiment or embodiments, equivalent alterations and modifications may occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein exemplary embodiment or embodiments of the invention. In addition, while a particular feature of the invention may have been described above with respect to only one or more of several embodiments, such feature may be combined with one or more other features of the other embodiments, as may be desired and advantageous for any given or particular application.

### INDUSTRIAL APPLICABILITY

The invention may find application in mid-size and large-size display and touch panel devices for industrial and consumer electronics. In particular, the invention may be used in products such as, but not limited to, Tablet PCs, Netbook PCs, Laptop PCs, mobile phones, personal digital assistants (PDAs), electronic books (eReaders), Satellite Navigation systems and the like.

1. A touch panel and display device, comprising:
a projected capacitance type touch panel; and
a display, the display including a plurality of pixels each including a pixel circuit having differential data inputs.

2. The touch panel and display device according to claim 1, wherein the display includes a data driver circuit configured to provide pairs of differential voltage signals to the differential data inputs of each of the pixel circuits.

3. The touch panel and display device according to claim 2, wherein the differential voltage signals in each pair have a sum which is a constant value and a difference representative of image data to be presented by the pixel circuit which receives the pair of differential voltage signals.

4. The touch panel and display device according to claim 2, wherein a polarity of the pairs of differential voltage signals provided to the pixel circuits is periodically reversed.

5. The touch panel and display device according to claim 1, wherein the touch panel includes:
a touch panel electrode array including an array of drive electrodes and an array of sense electrodes;
a drive circuit which supplies a voltage excitation signal to the drive electrodes; and
a sense circuit configured to sense coupling capacitance between the sense electrodes and the drive electrodes based on the voltage excitation signal.

6. The touch panel and display device according to claim 5, wherein the plurality of pixels are arranged in a matrix spatially aligned with the touch panel electrode array.

7. The touch panel and display device according to claim 1, wherein each pixel circuit is arranged so as to have a first half and a second half which are symmetrical and which each include a corresponding one of the differential data inputs.

8. The touch panel and display device according to claim 1,
wherein each pixel circuit includes: a first switch transistor; a second switch transistor; a first storage capacitor; a second storage capacitor; a first capacitive liquid crystal element; and a second capacitive liquid crystal element;
wherein a drain terminal of the first switch transistor is connected to a first terminal of the first storage capacitor and a first terminal of the first liquid crystal element; a drain terminal of the second switch transistor is connected to a first terminal of the second storage capacitor and a first terminal of the second liquid crystal element; a second terminal of the first liquid crystal element and a second terminal of the second liquid crystal element are connected together;
wherein a gate addressing line is connected to gate terminals of both the first switch transistor and second switch transistor; a first source addressing line is connected to a source terminal of the first switch transistor and a second source addressing line is connected to a source terminal of the second switch transistor; and the second terminal of the first storage capacitor and the second terminal of the second storage capacitor are connected to a common electrode line; and
wherein the first terminal of the first liquid crystal element and the first terminal of the second liquid crystal element respectively represent the differential data inputs of the pixel circuit.

9. The touch panel and display device according to claim 5, wherein the touch panel electrode array is formed on substrate and the plurality of pixels are formed on a different substrate.

10. The touch panel and display device according to claim 1, wherein the plurality of pixels include in-plane switching type liquid crystal materials.

11. The touch panel and display device according to claim 10, wherein each pixel circuit includes differential data inputs represented by inter-digitated first and second electrodes.

12. The touch panel and display device according to claim 5, wherein the touch panel electrode array is formed on a top surface of a counter substrate included in the display.

13. The touch panel and display device according to claim 1,
wherein each pixel circuit includes: a first switch transistor; a second switch transistor; a first capacitive liquid crystal element; a second capacitive liquid crystal element; and a storage capacitor;
wherein a drain terminal of the first switch transistor is connected to a first terminal of the first liquid crystal element and a first terminal of the storage capacitor; a drain terminal of the second switch transistor is connected to a first terminal of the second liquid crystal element and a second terminal of the storage capacitor; a second terminal of the first liquid crystal element and a second terminal of the second liquid crystal element are connected together such that a series combination of the first and second liquid crystal elements is in parallel with the storage capacitor;
wherein a gate addressing line is connected to gate terminals of both the first switch transistor and second switch transistor; a first source addressing line is connected to a source terminal of the first switch transistor and a second source addressing line is connected to a source terminal of the second switch transistor; and
wherein the first terminal of the first liquid crystal element and the first terminal of the second liquid crystal element respectively represent the differential data inputs of the pixel circuit.

14. The touch panel and display device according to claim 1, wherein the plurality of pixels are arranged in a matrix, adjacent pixels within a given row of the matrix share a source line, and two gate lines are provided for each row of pixels in the display.

15. The touch panel and display device according to claim 1, comprising:
a first substrate on which display electronic layers are formed, the display electronic layers including thin film transistors which are part of the pixel circuits; and
a second substrate on which touch panel electronic layers are formed, the touch panel electronic layers including a touch panel electrode array having sense electrodes and drive electrodes which are part of the projected capacitance type touch panel,
wherein the first substrate and the second substrate are arranged opposite each other with the display electronic layers and the touch panel electronic layers facing one another and separated by a layer of liquid crystal material.

16. The touch panel and display device according to claim 15, wherein the sense electrodes and drive electrodes function both as part of the touch panel, and as part of the display as counter electrodes.

17. The touch panel and display device according to claim 16, wherein the sense electrodes and the drive electrodes are patterned in a single layer.

18. The touch panel and display device according to claim 15, wherein the sense electrodes and the drive electrodes are aligned with the plurality of pixels.

19. The touch panel and display device according to claim 15, wherein the sense electrodes and drive electrodes in the touch panel electronic layers are formed by groups of pixel counter electrode segments serving as pixel counter electrodes in relation to the display electronic layers formed on the first substrate.

20. The touch panel and display device according to claim 19, wherein the pixel counter electrode segments in a given group are patterned as individual segments.

21. The touch panel and display device according to claim 19, wherein the pixel counter electrode segments in a given group are patterned to form one continuous area.

22. The touch panel and display device according to claim 15, wherein electrical connections to the touch panel electrode array are made to the first substrate, and the pixel circuits include switch transistors operative in a sensing function in combination with the touch panel electrode array.

23. The touch panel and display device according to claim 22, wherein a source line operative in the display to provide image data to a pixel circuit during a display period is operative to provide sensor data from the touch panel electrode array during a sensing period.

24. The touch panel and display device according to claim 22, wherein each pixel circuit includes: a first switch transistor; a second switch transistor; a first capacitive liquid crystal element; a second capacitive liquid crystal element; a first storage capacitor; a second storage capacitor; and a sensor switch transistor;
wherein a drain terminal of the first switch transistor is connected to a first terminal of the first liquid crystal element and a first terminal of the first storage capacitor; a drain terminal of the second switch transistor is connected to a first terminal of the second liquid crystal element and a first terminal of the second storage capacitor; a second terminal of the first liquid crystal element and a second terminal of the second liquid crystal element are connected together at a pixel common electrode node; and a second terminal of the first storage capacitor and a second terminal of the second storage capacitor are connected together at a sensing node; and
wherein the sensing node is connected to a drain terminal of the sensor switch transistor, a source terminal of which is connected to either of two source addressing lines and a gate terminal of which is connected to a sensor select addressing line.

25. The touch panel and display device according to claim 22, wherein each pixel circuit includes: a first switch transistor; a second switch transistor; a first capacitive liquid crystal element; a second capacitive liquid crystal element; a first storage capacitor; a second storage capacitor; a sensor amplifier transistor; and a sensor select transistor;
wherein a drain terminal of the first switch transistor is connected to a first terminal of the first liquid crystal element and a first terminal of the first storage capacitor; a drain terminal of the second switch transistor is connected to a first terminal of the second liquid crystal element and a first terminal of the second storage capacitor; a second terminal of the first liquid crystal element and a second terminal of the second liquid crystal element are connected together at a pixel common electrode node; and a second terminal of the first storage capacitor and a second terminal of the second storage capacitor are connected together at a sensing node;
wherein the sensing node is connected to a gate terminal of the sensor amplifier transistor, a source terminal of which is connected to a drain terminal of the sensor select transistor, and a drain terminal of which is connected to a sensor select addressing line; and
wherein a gate terminal of the sensor select transistor is connected to the sensor select addressing line and a source terminal of the sensor select transistor is connected to either of two source addressing lines.
